(19) United States
(12) Patent Application Publication
(10) Pub. No.: US 2019/0271965 A1
(43) Pub. Date: Sep. 5, 2019

(54) NUMERICAL CONTROLLER AND NUMERICAL CONTROL METHOD

(71) Applicant: Mitsubishi Electric Corporation, Chiyoda-ku Tokyo (JP)

(72) Inventors: Takeshi TSUDA, Tokyo (JP); Aya Kato, Tokyo (JP)

(73) Assignee: Mitsubishi Electric Corporation, Chiyoda-ku Tokyo (JP)

(21) Appl. No.: 15/778,078

(22) PCT Filed: Jul. 14, 2017
(86) PCT No.: PCT/JP2017/025753

§ 371 Date: May 22, 2018

(51) Int. Cl. G05B 19/408

(52) U.S. Cl. CPC G05B 19/4086; G05B 2219/36341; G05B 2219/33263

(57) ABSTRACT

A numerical controller includes an analysis unit to analyze a machining program and extract a coordinate rotation angle that is a rotation angle of a coordinate system specified in the machining program; and a coordinate transformation unit to transform a coordinate value in the machining program into a coordinate value in a machine tool to be controlled on the basis of polarity information created on the basis of at least one of a movement direction and a rotation direction of an axis of the machine tool, and the coordinate rotation angle.

### FIELD

The present invention relates to a numerical controller and a numerical control method for controlling a machine tool.

### BACKGROUND

Numerical controllers are devices that control machine tools on the basis of machining programs. Since various coordinate systems are used in control of machine tools, numerical controllers transform coordinates specified by a command in machining programs into coordinates in coordinate systems corresponding to the machine tools, and output move commands for the machine tools.

In a numerical controller described in Patent Literature 1, a coordinate system transformation unit that executes a coordinate system transformation process on a machining program transforms a command based on a right-handed coordinate system into a command based on a left-handed coordinate system so as to control a machine tool of the left-handed coordinate system.

### CITATION LIST

### Patent Literature

Patent Literature 1: Japanese Patent Application Laid-open No. 2016-24662

### SUMMARY

### Technical Problem

However, since the above-described conventional numerical controller of Patent Literature 1 does not assume a machine tool in which the left-handed coordinate system is employed for the rotation direction of the rotation axis, it is difficult to achieve control in consideration of the movement direction or the rotation direction of the axes of the machine tool, which is problematic.

The present invention has been made in view of the above, and it is an object of the present invention to provide a numerical controller and a numerical control method that can achieve control in consideration of at least one of the movement direction and the rotation direction of the axes of a machine tool.

### Solution to Problem

In order to solve the above-mentioned problem and to achieve the object, the numerical controller according to an aspect of the present invention includes an analysis unit to analyze a machining program and extract a rotation angle of a coordinate system specified in the machining program. Moreover, the numerical controller according to an aspect of the present invention includes a coordinate transformation unit to transform a coordinate value in the machining program into a coordinate value in a coordinate system of a machine tool to be controlled on a basis of polarity information created on a basis of at least one of a movement direction and a rotation direction of an axis of the machine tool, and the rotation angle.

### Advantageous Effects of Invention

The numerical controller according to the present invention has an effect of achieving control in consideration of at least one of the movement direction and the rotation direction of the axes of a machine tool.

### BRIEF DESCRIPTION OF DRAWINGS

FIG. 1 is a block diagram illustrating a configuration of a numerical controller according to a first embodiment of the present invention.

FIG. 2 is a flowchart illustrating a calculation processing procedure of a coordinate transformation matrix according to the first embodiment.

FIG. 3 is a diagram illustrating a configuration of a tool tilt type machine tool according to the first embodiment.

FIG. 4 is a diagram illustrating a configuration of a compound type machine tool according to the first embodiment.

FIG. 5 is a diagram illustrating a configuration of a table tilt type machine tool according to the first embodiment.

FIG. 6 is a diagram illustrating the relationship between machine configurations and rotation axes according to the first embodiment.

FIG. 7 is a block diagram illustrating a configuration of a numerical controller according to a second embodiment.

FIG. 8 is a diagram for explaining a machine configuration of a spindle fixed type machine tool according to the second embodiment.

FIG. 9 is a diagram for explaining a machine configuration of a spindle moving type machine tool according to the second embodiment.

FIG. 10 is a diagram illustrating a configuration of a polarity information table according to the second embodiment.

FIG. 11 is a block diagram illustrating a configuration of a numerical controller according to a third embodiment.

FIG. 12 is a diagram for explaining the relationship between a left-handed coordinate system and reference right-handed coordinate systems according to the third embodiment.

FIG. 13 is a flowchart illustrating a setting processing procedure of polarity information according to the third embodiment.

FIG. 14 is a diagram illustrating setting examples of polarity information according to the third embodiment.

FIG. 15 is a diagram illustrating an exemplary hardware configuration of the numerical controllers according to the first to third embodiments.

### DESCRIPTION OF EMBODIMENTS

Hereinafter, a numerical controller and a numerical control method according to embodiments of the present invention will be described in detail with reference to the drawings. The present invention is not limited to the embodiments.

### First Embodiment

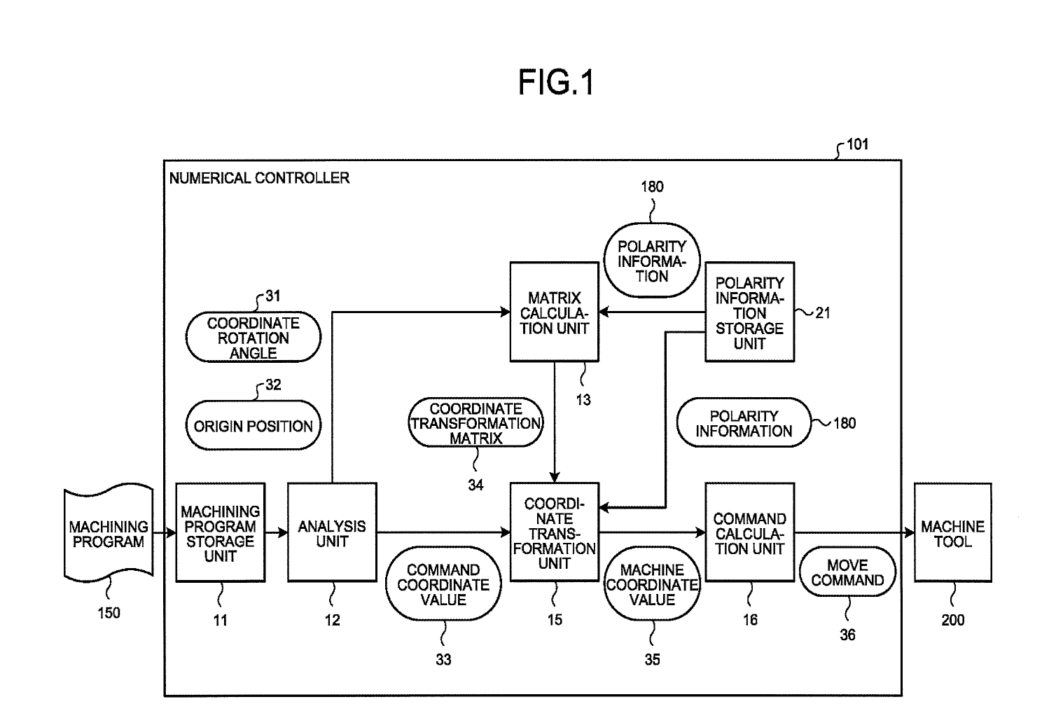

FIG. 1 is a block diagram illustrating a configuration of a numerical controller according to a first embodiment of the present invention. A numerical controller (NC) 101 is a computer that generates a move command 36 for a machine tool 200 on the basis of a machining program 150 for machining a workpiece. In the first embodiment, a case where a left-handed coordinate system is employed for the rotation axes of the machine tool 200 will be described.

The machine tool 200 is a machine such as a machining center for machining a workpiece in accordance with the move command 36 from the numerical controller 101. The machine tool 200 has a plurality of axes for machining a workpiece that is an object to be machined. One of the axes of the machine tool 200 is an axis for changing the tool posture of a tool attached to the machine tool 200. The machine tool 200 can change the tool posture relative to the workpiece by movement of a movement axis along the axis or rotation of a rotation axis, each of the movement axis and the rotation axis being at least one of the axes. The tool attached to the machine tool 200 rotates to cut the workpiece and form a hole or recess in the workpiece.

The machine tool 200 includes a table on which a workpiece is placed. One of the axes of the machine tool 200 is an axis for rotating the table. The machine tool 200 further includes an X-axis, a Y-axis, and a Z-axis for translating the entire machine tool 200 in an X-direction, a Y-direction, and a Z-direction, respectively. Each of the X-axis, the Y-axis, and the Z-axis is a corresponding one of the axes of the machine tool 200.

The X-axis, the Y-axis, and the Z-axis of the machine tool 200 are linear movement axes. In the machine tool 200, an A-axis, a B-axis, and a C-axis are rotation axes that rotate around the X-axis, the Y-axis, and the Z-axis, respectively.

The numerical controller 101 controls the machine tool 200 by using the machining program 150 that is a user program. After performing coordinate transformation on coordinate values read from the machining program 150, the numerical controller 101 generates the move command 36 for the machine tool 200 by using the coordinate values after the coordinate transformation.

The numerical controller 101 controls the position and the posture of the tool with respect to the workpiece by controlling the movements of the axes of the machine tool 200. The movements of the axes of the machine tool 200 are translation or rotation. An example of a component that can be moved on the axes is the tool and/or the table.

The numerical controller 101 includes a machining program storage unit 11 and an analysis unit 12. The machining program storage unit 11 stores the machining program 150. The analysis unit 12 reads the machining program 150 from the machining program storage unit 11 and analyzes the machining program 150. The numerical controller 101 further includes a polarity information storage unit 21 and a matrix calculation unit 13. The polarity information storage unit 21 stores polarity information 180 described later. The matrix calculation unit 13 derives a coordinate transformation matrix 34 by a calculation process. The numerical controller 101 further includes a coordinate transformation unit 15 and a command calculation unit 16. The coordinate transformation unit 15 transforms a command coordinate value 33 in the machining program 150 into a coordinate value of the machine tool 200. The command calculation unit 16 calculates the move command 36 corresponding to the transformed coordinate value.

In the numerical controller 101, the analysis unit 12 is connected to the machining program storage unit 11, the matrix calculation unit 13, and the coordinate transformation unit 15. In the numerical controller 101, the matrix calculation unit 13 is connected to the polarity information storage unit 21 and the coordinate transformation unit 15, and the coordinate transformation unit 15 is connected to the command calculation unit 16. The command calculation unit 16 is connected to the machine tool 200.

The machining program storage unit 11 is a storage device such as a memory that stores the machining program 150 that is input information from the outside. The analysis unit 12 reads a command from the machining program 150 in the machining program storage unit 11 and calculates a movement amount of each of the axes on the basis of the read command.

The analysis unit 12 analyzes the machining program 150 to extract and output an origin position and a rotation angle of a coordinate system specified in the machining program 150. Specifically, the analysis unit 12 outputs, to the matrix calculation unit 13, a set value for an XYZ address indicated by using a G code in an N11 block described later as an origin position 32, and outputs, to the matrix calculation unit 13, a set value for an IJK address indicated by using a G code in the N11 block described later as a coordinate rotation angle 31. The coordinate rotation angle 31 is a rotation angle in the coordinate system specified in the machining program 150. The coordinate rotation angle 31 is specified in the machining program 150 together with the coordinate system.

The analysis unit 12 generates information necessary for calculating the move command 36 corresponding to the command described in the machining program 150. An example of the information is the command coordinate value 33 in each of an N10 block, an N13 block, and an N14 block described in a first machining program described later. The analysis unit 12 outputs the command coordinate values 33 in the N10 block, the N13 block, and the N14 block to the coordinate transformation unit 15 as axial movement that is movement coordinates of each block. An example of the command coordinate value 33 output by the analysis unit 12 to the coordinate transformation unit 15 is a coordinate value in an inclined plane coordinate system.

The matrix calculation unit 13 is a transformation information calculation unit and uses the polarity information 180, the origin position 32 that is the output result of the analysis unit 12, and the coordinate rotation angle 31 that is the output result of the analysis unit 12 to translate and rotate the inclined plane coordinate system. As a result, the matrix calculation unit 13 calculates coordinate transformation information used for performing coordinate transformation between the inclined plane coordinate system and a workpiece coordinate system. An example of the coordinate transformation information is the coordinate transformation matrix 34 for performing coordinate transformation between the inclined plane coordinate system and the workpiece coordinate system. Hereinafter, a case where the coordinate transformation information is the coordinate transformation matrix 34 will be described. The matrix calculation unit 13 outputs the calculated coordinate transformation matrix 34 to the coordinate transformation unit 15.

The matrix calculation unit 13 derives an identity matrix as the coordinate transformation matrix 34 when a G68.2 command indicating an inclined plane machining mode is not valid. The identity matrix is a command not to perform any of translation and rotation on the coordinate system. When the coordinate transformation matrix 34 derived by the matrix calculation unit 13 is an identity matrix, neither translation of the coordinate system nor rotation of the coordinate system is performed.

The polarity information storage unit 21 is a storage device such as a memory that stores the polarity information 180. The polarity information 180 is information created on the basis of the machine configuration of the machine tool 200, the movement direction of each linear axis, and the rotation direction of each rotation axis, and indicates whether the axes of the machine tool 200 are axes in accordance with the right-handed coordinate system. It is sufficient if the polarity information 180 is created on the basis of at least one of the movement direction and the rotation direction of the axes of the machine tool 200 and the machine configuration of the machine tool 200. The polarity information 180 is set for each of the axes of the machine tool 200. The polarity information 180 is either information indicating that an axis is in accordance with the right-handed coordinate system or information indicating that an axis is in accordance with the left-handed coordinate system. The polarity information 180 is used when the matrix calculation unit 13 determines whether an axis is in accordance with the right-handed coordinate system.

Specifically, as the polarity information 180, “0” is set for an axis that is in accordance with the right-handed coordinate system, and “1” is set for an axis that is in accordance with the left-handed coordinate system. That is, with respect to the machine tool 200 that is in accordance with the right-handed coordinate system, the polarity information 180 on all the axes is set to “0”, and with respect to the machine tool 200 that is in accordance with the left-handed coordinate system, the polarity information 180 on at least one axis is set to “1”.

The polarity described in the first embodiment is used as a term that indicates the movement direction with respect to each linear axis and indicates the rotation direction with respect to each rotation axis. An axis that is not in accordance with the right-handed coordinate system may be referred to as an axis of reverse polarity.

On the basis of the command coordinate value 33 input from the analysis unit 12, the coordinate transformation matrix 34 input from the matrix calculation unit 13, and the polarity information 180 in the polarity information storage unit 21, the coordinate transformation unit 15 calculates a machine coordinate value 35. The machine coordinate value 35 is a coordinate value in a machine coordinate system that is a coordinate system of the machine tool 200. The coordinate transformation unit 15 interpolates between the start point and the end point of each movement section of each axis by a method indicated by the machining program 150 such as linear interpolation or circular interpolation, and then calculates the machine coordinate values 35 at each interpolation point.

The command calculation unit 16 calculates the move command 36 for each of the axes of the machine tool 200 by performing an acceleration/deceleration process on a value of a position command for each axis on the basis of the machine coordinate value 35. The value of the position command for each axis is a value of the position command in the coordinate system at each interpolation point. The command calculation unit 16 transmits the calculated move command 36 to the machine tool 200. The machine tool 200 drives each axis such that the position of each of the axes of the machine tool 200 follows the move command 36 for a corresponding axis.

In the machining program 150, the operation of the tool with respect to the workpiece is described, and information defining the coordinate system indicated to the machine tool 200 is included. In the following description, a coordinate system in the machining program 150 is referred to as a coordinate system defined by the machining program 150, and a coordinate system transformed by the numerical controller 101 is referred to as a coordinate system set by the numerical controller 101. Here, a first machining program as a first example of the machining program 150 will be described. The first machining program is described as follows.

### <First Machining Program>

### N10 G54 G0X100.Y100.Z0.

### N11 G68.2P5X10.Y10.Z10.I0.J30.K60.

### N12 G53.1

### N13 G1 Z−10. F1000.

### N14 G1 X10.

### N20 G69

:
:

In the first machining program, sequence numbers each using an N address are described on the left side. Although the sequence numbers are not related to the movement of the axes, the sequence numbers are described conveniently for the sake of explanation. In the following description, one line of the first machining program is expressed as a block.

In the N10 block, the G54 command specifies a coordinate system to be used, and the rapid traverse command G0 is a command to move the tool to the position (X,Y,Z)=(100,100,0) in a G54 coordinate system. A plurality of workpiece coordinate systems can be set, and the G54 coordinate system is one of the workpiece coordinate systems and is a coordinate system defined by presetting the distance from the machine origin of the machine tool 200. The workpiece coordinate system is a coordinate system relative to the workpiece. As described above, a command to perform high speed movement of the tool at a rapid traverse speed is described in the N10 block.

In the N11 block, the G68.2 command defines the inclined plane coordinate system that is a coordinate system relative to an inclined plane. The G68.2 command is an inclined plane machining command that executes a function of five-axis machining. The G68.2 command is a command to set an origin of a given plane such as an inclined plane at a given position as a feature coordinate system by giving a difference from the origin of the workpiece coordinate system. As described above, the G68.2 command sets the feature coordinate system that is a coordinate system representing the inclined plane on the workpiece. When the numerical controller 101 defines the inclined plane coordinate system by specifying the origin and the rotation angle based on the G68.2 command, it becomes possible to issue a program command for the inclined plane coordinate system.

A P address specifies a method for defining the inclined plane coordinate system and a P5 command specifies the rotation angle of the inclined plane coordinate system by using the rotation axis angles that are the rotation angles of the axes of the machine tool 200. The XYZ address is used to set the origin position 32 of the inclined plane coordinate system to coordinate values of the G54 coordinate system. Here, the position corresponding to the coordinate values (X,Y,Z)=(10,10,10) in the G54 coordinate system is specified as the origin of the inclined plane coordinate system. The IJK address is used to set the rotation angle of the coordinate system. By setting the rotation angle of the coordinate system to, for example, I0.J30.K60 with the IJK address, the first machining program can set a given coordinate system. The command of the N11 block here specifies a B-axis angle, which is the rotation angle of the B-axis, with the J address and a C-axis angle, which is the rotation angle of the C-axis, with the K address. The I address is used to specify an A-axis angle, which is the rotation angle of the A-axis, when the machine tool 200 includes the A-axis.

The first machining program uses a method for defining coordinate system rotation using the rotation axis angles of the axes of the machine tool 200 for the G68.2P5 command, but the command may be replaced by existing definition methods such as specification of a roll angle, a pitch angle, and a yaw angle, as long as the definition method uses the rotation axis angles of the axes of the machine tool 200.

In the N12 block, the G53.1 command makes the Z-axis direction of the inclined plane coordinate system coincide with the tool direction. When the G53.1 command is issued, the rotation angle of each rotation axis is positioned at an angle calculated inside the numerical controller 101.

When the G53.1 command rotates a rotation axis of a table with respect to a machine configuration in which the table includes the rotation axis, the coordinate system is redefined that is associated with the rotation of the table. In that case, the command of the N12 block fixes the inclined plane coordinate system before the G53.1 command to the rotary table, and redefines the inclined plane coordinate system such that the relationship between the rotary table before the G53.1 command and the inclined plane coordinate system is maintained in a state after the table is rotated.

After the command in the N13 block and until a G69 command issued in an N20 block, the numerical controller 101 issues an axial move command for the inclined plane coordinate system with the first machining program, whereby desired machining can be performed on the inclined plane.

In the N13 block, the G1 command as a cutting command executes axial movement. Specifically, the G1 command moves the tool to the position of a coordinate value Z−10. on the inclined plane coordinate system at a feed speed of 1000 mm/min by F1000. Thereafter, the command of the N14 block moves the tool to the coordinate position of X10.

The G69 command in the N20 block is a command to cancel the definition of the inclined plane coordinate system. When the G69 command is executed, the machine tool 200 operates assuming that the G54 coordinate system that is the coordinate system before the G68.2 command has been defined as the coordinate system after the G69 command. The inclined plane coordinate system described in the first embodiment and inclined plane coordinate systems described in second and third embodiments described later may be either a plane coordinate system with inclination or a plane coordinate system without inclination.

In the first embodiment, the case has been described where the numerical controller 101 performs coordinate transformation on the position command after interpolation. However, the numerical controller 101 may obtain a position command at an interpolation point by performing coordinate transformation on position commands of the start point and the end point of each movement section and by performing interpolation on the position commands after the coordinate transformation.

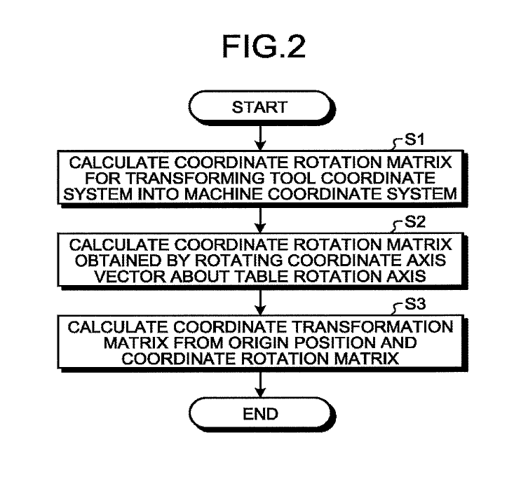

Next, a calculation processing procedure of the coordinate transformation matrix 34 by the matrix calculation unit 13 will be described with reference to a flowchart of FIG. 2. FIG. 2 is the flowchart illustrating the calculation processing procedure of the coordinate transformation matrix according to the first embodiment. In Step S1, the matrix calculation unit 13 calculates a coordinate rotation matrix for transforming a tool coordinate system into a machine coordinate system. In other words, the matrix calculation unit 13 calculates a coordinate rotation matrix from the tool coordinate system to the machine coordinate system. The tool coordinate system is a coordinate system relative to a tool attached to the machine tool 200 and the machine coordinate system is a coordinate system relative to the machine tool 200. The matrix calculation unit 13 calculates the coordinate rotation matrix in consideration of polarity information on the tool-side rotation axis in the polarity information 180 and the coordinate rotation angle 31 that is a rotation angle of the rotation axis. In that case, the matrix calculation unit 13 calculates the coordinate rotation matrix by performing the rotation on the coordinate system only, without performing concurrent movement thereof.

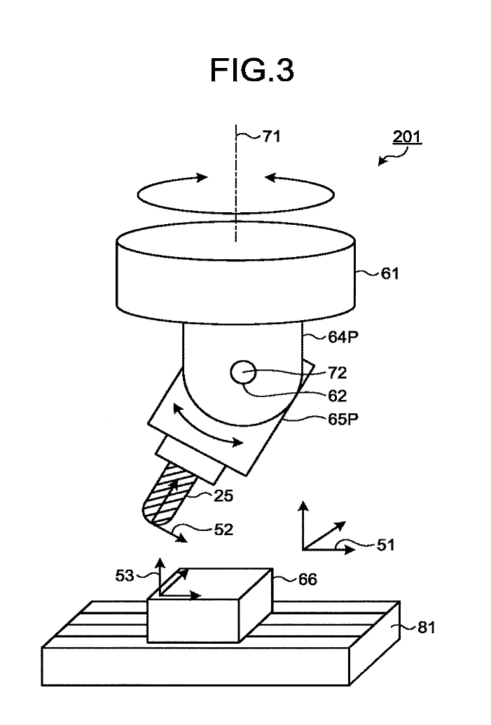

Here, an exemplary configuration of the machine tool 200 and a coordinate rotation matrix corresponding to the configuration of the machine tool 200 will be described. FIG. 3 is a diagram illustrating a configuration of a tool tilt type machine tool according to the first embodiment. A machine tool 201, which is a tool tilt type machine tool, is an example of the machine tool 200. Here, a process using the polarity information 180 on the B-axis or the C-axis that is the rotation axis of a tool 25 will be described.

The machine tool 201 includes a rotation unit 62 and a rotation unit 61. The rotation unit 62 rotates about a rotation axis 72, which is a first rotation axis. The rotation unit 61 rotates about a rotation axis 71, which is a second rotation axis. The rotation axes 71 and 72 and rotation axes 73 to 76 described later are examples of the rotation axis.

The machine tool 201 further includes a joint unit 64P, which connects the rotation unit 61 and the rotation unit 62. The machine tool 201 further includes a holding unit 65P, which is connected to the rotation unit 62 and holds the tool 25. The machine tool 201 further includes a table 81, which holds a workpiece 66. With this configuration, the machine tool 201 can change the tool posture by the rotation unit 61 rotating about the rotation axis 71, and can change the tool posture by the rotation unit 62 rotating about the rotation axis 72.

In the machine tool 201, a tool coordinate system 52 is a coordinate system relative to the tool 25, a table coordinate system 53 is a coordinate system relative to the table 81, and a machine coordinate system 51 is a coordinate system relative to the machine tool 201.

The tool coordinate system 52 in the machine configuration of the machine tool 201 is a coordinate system defined by rotating the machine coordinate system 51 about the rotation axis 71 by an angle Cr and then rotating the machine coordinate system 51 about the rotation axis 72 by an angle Br.

When the coordinate rotation matrix is expressed as Rot(r,θ), in which r is a rotation center vector and θ is a rotation angle, a coordinate rotation matrix in a case of rotation by the rotation angle θ about the X-axis, the Y-axis, and the Z-axis, is expressed by the following formula (1).

$$\begin{matrix}[ Formula 1 ] & \\ \begin{matrix}Rot ( {r}_{X} , θ ) = [ \begin{matrix}1 & 0 & 0 \\ 0 & cos θ & - sin θ \\ 0 & sin θ & cos θ\end{matrix} ] , \\ Rot ( {r}_{Y} , θ ) = [ \begin{matrix}cos θ & 0 & sin θ \\ 0 & 1 & 0 \\ - sin θ & 0 & cos θ\end{matrix} ] , \\ Rot ( {r}_{Z} , θ ) = [ \begin{matrix}cos θ & - sin θ & 0 \\ sin θ & cos θ & 0 \\ 0 & 0 & 1\end{matrix} ]\end{matrix} \} & ( 1 )\end{matrix}$$

Subscripts X, Y, and Z written at the lower right of r in the formula (1) indicate the X-axis, the Y-axis, and the Z-axis, respectively. After calculating the coordinate rotation matrix using the formula (1), the matrix calculation unit 13 calculates, using the following formula (2), coordinate axis vectors that take rotation axis polarity into consideration.

[Formula 2]

Coordinate axis vector=Rot(r_{Z},k_{C}×γ)Rot(r_{Y},k_{B}×β) (2)

As a result, the matrix calculation unit 13 can obtain each coordinate axis vector of the tool coordinate system 52 transformed into the machine coordinate value 35. In the formula (2), k_{B} and k_{C} are variables whose values are set in accordance with B-axis polarity and C-axis polarity. The variables are set to “1” when the rotation axis polarity is in accordance with the right-handed coordinate system, and are set to “−1” when the rotation axis polarity is in accordance with an axis of reverse polarity. Subscripts B and C written at the lower right of k indicate the B-axis and the C-axis, respectively, and are applied to the linear axes as well as the rotation axes 71 and 72.

As described above, the matrix calculation unit 13 derives the coordinate rotation matrix that takes into consideration the polarity of each of the rotation axes 71 and 72 in the process of Step S1. This coordinate rotation matrix corresponds to the process of rotating the coordinate system about the Z-axis by an angle that takes into consideration the polarity information on the C-axis, and then rotating the coordinate system about the Y-axis by an angle that takes into consideration the polarity information on the B-axis in the machine configuration of the machine tool 201.

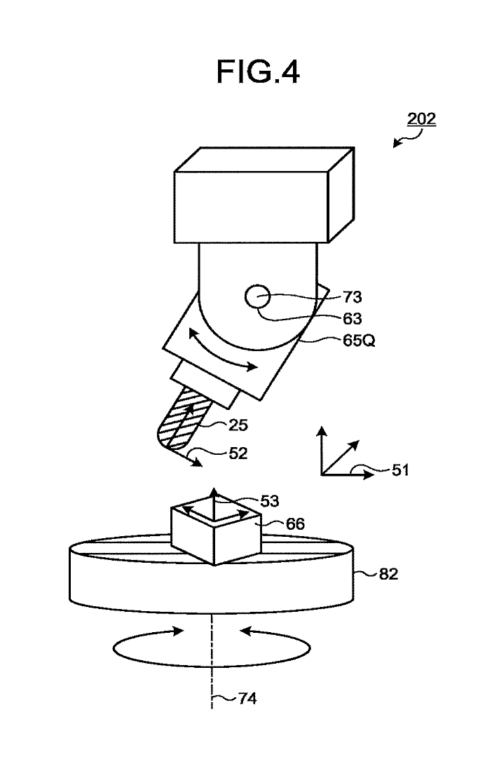

The machine tool 200 is not limited to the tool tilt type machine tool 201 illustrated in FIG. 3, and may be a table tilt type machine tool 203 described later or a compound type machine tool 202 described later. FIG. 4 is a diagram illustrating a configuration of the compound type machine tool according to the first embodiment. The machine tool 202, which is a compound type machine tool, is an example of the machine tool 200. The machine tool 202 is a machine in which a part of the tool tilt type machine tool 201 and a part of the table tilt type machine tool 203 are compounded, and each of the tool 25 and a table 82 of the machine tool 202 has one rotation axis.

The machine tool 202 includes a rotation unit 63 and a holding unit 65Q. The rotation unit 63 rotates about the rotation axis 73. The holding unit 65Q is connected to the rotation unit 63 and holds the tool 25. The machine tool 202 further includes the table 82, which holds the workpiece 66 and rotates about the rotation axis 74. In the machine tool 202, the rotation axis 73 is a first rotation axis and the rotation axis 74 is a second rotation axis.

With this configuration, the machine tool 202 can change the tool posture by the rotation unit 63 rotating about the rotation axis 73, and can change the posture of the workpiece 66 by the table 82 rotating about the rotation axis 74.

In the machine tool 202, the tool coordinate system 52 is a coordinate system relative to the tool 25, the table coordinate system 53 is a coordinate system relative to the table 82, and the machine coordinate system 51 is a coordinate system relative to the machine tool 202.

The tool coordinate system 52 in the machine configuration of the machine tool 202 is a coordinate system defined by rotating the machine coordinate system 51 about the rotation axis 73 by the angle Br. Therefore, in the case of the machine tool 202, in Step S1, the matrix calculation unit 13 performs a process of rotating a coordinate system by an angle that takes into consideration the B-axis that is the rotation axis 73 of the tool 25 and the polarity information on the B-axis, thereby calculating a coordinate rotation matrix. Specifically, after calculating the coordinate rotation matrix, the matrix calculation unit 13 calculates, using the following formula (3), coordinate axis vectors that take the rotation axis polarity into consideration.

[Formula 3]

Coordinate axis vector=Rot(r_{Y},k_{B}×β) (3)

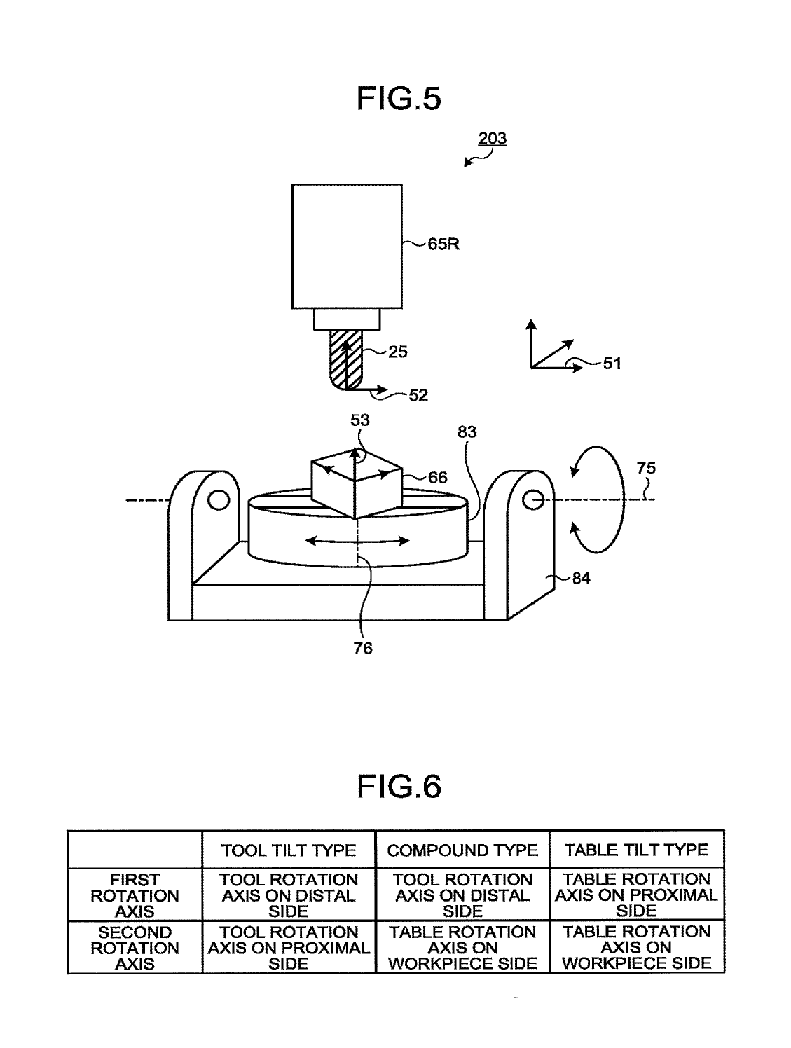

FIG. 5 is a diagram illustrating a configuration of the table tilt type machine tool according to the first embodiment. The machine tool 203, which is a table tilt type machine tool, is an example of the machine tool 200. In the machine tool 203, the tool 25 does not have a rotation axis but a table 83 has two rotation axes 75 and 76.

The machine tool 203 includes a holding unit 65R, which holds the tool 25. The machine tool 203 further includes the table 83, which holds the workpiece 66 and rotates about the rotation axis 76. The machine tool 203 further includes a tilt base 84, which tilts the table 83 on the rotation axis 75. In the machine tool 203, the rotation axis 75 is a first rotation axis and the rotation axis 76 is a second rotation axis.

In the machine tool 203, the table 83 is connected to the tilt base 84. With this configuration, the machine tool 203 can change the posture of the workpiece 66 by the table 83 rotating about the rotation axis 76, and can change the posture of the workpiece 66 by the tilt base 84 tilting on the rotation axis 75.

In the machine tool 203, the tool coordinate system 52 is a coordinate system relative to the tool 25, the table coordinate system 53 is a coordinate system relative to the table 83, and the machine coordinate system 51 is a coordinate system relative to the machine tool 203.

Since the machine tool 203 has such a machine configuration that the tool 25 does not have a rotation axis, the tool coordinate system 52 and the workpiece coordinate system are in the same direction. Therefore, in the case of the machine tool 203, in Step S1, the matrix calculation unit 13 calculates the coordinate rotation matrix without taking the rotation axis of the tool 25 into consideration. Specifically, the matrix calculation unit 13 calculates the coordinate rotation matrix using the formula (1), and then calculates, using the following formula (4), coordinate axis vectors without taking the rotation axis polarity of the tool 25 into consideration.

$$\begin{matrix}[ Formula 4 ] & \\ Coordinate axis vector = [ \begin{matrix}1 & 0 & 0 \\ 0 & 1 & 0 \\ 0 & 0 & 1\end{matrix} ] & ( 4 )\end{matrix}$$

With the machine configurations of the machine tools 201 to 203, the first and second rotation axes are defined such that the first rotation axis is a rotation axis closer to the origin of the tool coordinate system 52 and the second rotation axis is a rotation axis closer to the origin of the workpiece coordinate system. That is, the rotation axes of the machine tools 201 to 203 are defined as illustrated in FIG. 6.

FIG. 6 is a diagram illustrating the relationship between the machine configurations and the rotation axes according to the first embodiment. As illustrated in FIG. 6, in a case of the tool tilt type, the first rotation axis is a tool rotation axis on the distal side and the second rotation axis is a tool rotation axis on the proximal side. Here, the tool rotation axis on the distal side is the rotation axis 72, and the tool rotation axis on the proximal side is the rotation axis 71.

In a case of the compound type, the first rotation axis is a tool rotation axis on the distal side and the second rotation axis is a table rotation axis on a workpiece side. Here, the tool rotation axis on the distal side is the rotation axis 73, and the table rotation axis on the workpiece side is the rotation axis 74.

In a case of the table tilt type, the first rotation axis is a table rotation axis on the proximal side and the second rotation axis is a table rotation axis on the workpiece side. Here, the table rotation axis on the proximal side is the rotation axis 75, and the table rotation axis on the workpiece side is the rotation axis 76.

Next, in Step S2, the matrix calculation unit 13 calculates a coordinate rotation matrix obtained by rotating the coordinate axis vectors that are tool posture vectors about the table rotation axis. The coordinate axis vectors used by the matrix calculation unit 13 here are vectors constituting the coordinate rotation matrix calculated in Step S1. The matrix calculation unit 13 rotates the coordinate axis vectors about the table rotation axis, in consideration of the polarity information 180 on the rotation axes 74 to 76, which are table rotation axes, and the rotation angles of the rotation axes 74 to 76. As a result, the coordinate axis vectors of the coordinate rotation matrix are transformed from the table coordinate system 53 into the workpiece coordinate system.

In the case of the tool tilt type machine tool 201, the machine configuration thereof does not have a table rotation axis, and therefore, the matrix calculation unit 13 terminates Step S2 without performing coordinate transformation for table rotation. That is, the matrix calculation unit 13 sets, as the coordinate rotation matrix after rotation, each coordinate axis vector calculated using the above-described formula (2) as it is.

In the case of the compound type machine tool 202, since the table 82 has one C-axis that is the rotation axis 74, the matrix calculation unit 13 rotates the coordinate system about the Z-axis by the C-axis angle that takes into consideration the polarity information 180. Specifically, the matrix calculation unit 13 performs calculation of the formula (5) obtained by adding rotation of the coordinate system corresponding to the C-axis to the transformation formula of the formula (3). R in the formula (5) is a coordinate rotation matrix after coordinate transformation corresponding to table rotation.

[Formula 5]

R=Rot(r_{Z},k_{C}×γ)Rot(r_{Y},k_{B}×β) (5)

In the case of the table tilt type machine tool 203, the matrix calculation unit 13 rotates the vectors of the coordinate rotation matrix indicated by the formula (4) about the Z-axis and then about the X-axis by an angle Ar, thereby calculating the coordinate rotation matrix after rotation. Specifically, the matrix calculation unit 13 calculates, using the following formula (6), a coordinate rotation matrix after coordinate transformation corresponding to table rotation. k_{A} in the formula (6) is a value set in accordance with the polarity of the A-axis, and is a value set similarly to k_{B} and k_{C}.

[Formula 6]

R=Rot(r_{Y},k_{A}×α)Rot(r_{Z},k_{C}×γ) (6)

In Step S3, the matrix calculation unit 13 calculates the coordinate transformation matrix 34 on the basis of the origin position 32 indicated by the inclined plane machining command and the coordinate rotation matrix calculated in Step S2. Specifically, the matrix calculation unit 13 calculates the coordinate transformation matrix 34 using the following formula (7). In the formula (7), the coordinate transformation matrix 34 is represented by T.

$$\begin{matrix}[ Formula 7 ] & \\ T = [ \begin{matrix}R & p \\ 0 & 1\end{matrix} ] & ( 7 )\end{matrix}$$

The numerical controller 101 uses the coordinate transformation matrix 34 calculated using the formula (7) at the time of the G68.2 command. The coordinate transformation matrix 34 indicated by the formula (7) is obtained by adding the polarity information 180 on the rotation axes 71 to 76 to the calculation of the coordinate rotation matrix, and further adding the polarity of the linear axes to the origin position 32. That is, R in the formula (7) is the coordinate axis vector of the formula (2), R in the formula (6), or R in the formula (5), and p in the formula (7) is a vector of translation of linear axes. Therefore, the coordinate transformation matrix 34 indicated by the formula (7) is a matrix that can specify coordinate values of the left-handed coordinate system.

With the flowchart of FIG. 2, the calculation procedure of the coordinate transformation matrix 34 in the five-axis machine tool 200 has been described. However, even in the case of a six-axis machine tool 200, the coordinate transformation matrix 34 can be calculated by using procedures similar to those in Steps S1 to S3 described above.

In one of the six-axis machine tools 200, the tool 25 has two rotation axes and the table has one rotation axis. For such a six-axis machine tool 200, it is sufficient if the numerical controller 101 calculates a coordinate rotation matrix for transforming the tool coordinate system 52 into the workpiece coordinate system in the process of Step S1. In other words, in the process of Step S1, it is sufficient if the numerical controller 101 calculates a coordinate rotation matrix from the tool coordinate system 52 to the workpiece coordinate system. As a result, the numerical controller 101 can calculate the coordinate transformation matrix 34 for the six-axis machine tool 200 as well.

Next, an operation of the coordinate transformation unit 15 will be described. The coordinate transformation unit 15 performs coordinate transformation using the polarity information 180 and the coordinate transformation matrix 34. The coordinate transformation matrix 34 is calculated by the matrix calculation unit 13 in consideration of the machine configuration of the machine tool 200. Here, a case where the matrix calculation unit 13 derives the coordinate transformation matrix 34 indicated by the following formula (8) will be described.

$$\begin{matrix}[ Formula 8 ] & \\ T = [ \begin{matrix}Rot ( {r}_{Y} , {k}_{B} \times β ) & p \\ 0 & 1\end{matrix} ] = [ \begin{matrix}cos β & 0 & {k}_{B} sin β & 0 \\ 0 & 1 & 0 & 0 \\ - {k}_{B} sin β & 0 & cos β & 0 \\ 0 & 0 & 0 & 1\end{matrix} ] & ( 8 )\end{matrix}$$

The numerical controller 101 recognizes a move command during machining of the inclined plane as the coordinate value on the inclined plane coordinate system and then calculates a movement amount by which each axis is moved. The machining program 150 in some cases issue a move command to move to coordinate values such as (X,Y,Z)=(10,0,0) after the inclined plane machining command. In such a case, if the polarity of the B-axis is in accordance with the right-handed coordinate system, the coordinate transformation unit 15 generates the move command 36 such that the position of the tool 25, which is a machine value, moves to the position that can be calculated using the following formula (9). In the formula (9), numerical values in a case of R=45 deg are indicated.

$$\begin{matrix}[ Formula 9 ] & \\ [ \begin{matrix}cos β & 0 & sin β \\ 0 & 1 & 0 \\ - sin β & 0 & cos β\end{matrix} ] [ \begin{matrix}10. \\ 0. \\ 0.\end{matrix} ] = [ \begin{matrix}\frac{10}{\sqrt{2}} \\ 0. \\ - \frac{10}{\sqrt{2}}\end{matrix} ] = [ \begin{matrix}7.071 \\ 0. \\ - 7.071\end{matrix} ] & ( 9 )\end{matrix}$$

In contrast, when the polarity of the B-axis is reverse polarity that is not in accordance with the right-handed coordinate system, that is, the polarity of the B-axis is in accordance with the left-handed coordinate system, the coordinate transformation unit 15 generates the move command 36 such that the machine value moves to the position that can be calculated using the following formula (10).

$$\begin{matrix}[ Formula 10 ] & \\ [ \begin{matrix}cos β & 0 & - sin β \\ 0 & 1 & 0 \\ sin β & 0 & cos β\end{matrix} ] [ \begin{matrix}10. \\ 0. \\ 0.\end{matrix} ] = [ \begin{matrix}\frac{10}{\sqrt{2}} \\ 0. \\ \frac{10}{\sqrt{2}}\end{matrix} ] = [ \begin{matrix}7.071 \\ 0. \\ 7.071\end{matrix} ] & ( 10 )\end{matrix}$$

As seen from the above, when the polarity of the B-axis is in accordance with the left-handed coordinate system, the sign of the coordinate value of the Z-axis is inverted compared to a case where the polarity of the B-axis is in accordance with the right-handed coordinate system. That is, when comparing the calculation result of the formula (10) with the calculation result of the formula (9), the absolute value of the coordinate value indicated in the formula (10) and the absolute value of the coordinate value indicated in the formula (9) are the same but the sign of the coordinate value of the Z-axis is inverted. Therefore, the formulas (10) and (9) indicate that axial movement in the left-handed coordinate system is correctly performed. In other words, the formulas (10) and (9) indicate that it is possible to set coordinates on the inclined plane using a mechanical angle of the left-handed machine tool 200.

In a case of coordinate transformation requiring C-axis rotation, the numerical controller 101 calculates the B-axis angle and the C-axis angle by the G53.1 command. In such a case, the numerical controller 101 calculates the rotational axis angles from the obtained inclined plane coordinate system, and thus calculates the mechanical angle that takes into consideration the polarity information 180. As a result, the numerical controller 101 performs positioning to the calculated angle after the G53.1 command.

<Mode for Rotating Coordinate System about Feature Z-Axis>

In the first embodiment, the case has been described where the machine tool 200 operates with the first machining program in which the inclined plane coordinate system is defined by specifying the coordinate rotation angle 31 for two machine rotation axes with the JK address. However, the machine tool 200 may be configured such that the coordinate system can be rotated about one more axis in addition to the rotation of the two machine rotation axes. For example, the matrix calculation unit 13 may add coordinate rotation about the Z-axis using an R address to the coordinate rotation matrix obtained in Step S2 of the flowchart of FIG. 2. By specifying such an additional rotation angle, the matrix calculation unit 13 can define a given coordinate system at a given position.

As described above, since the numerical controller 101 calculates the coordinate transformation matrix 34 on the basis of the rotation angle and the polarity information 180 of the machine tool 200, the numerical controller 101 can easily perform setting of the inclined plane coordinate system using the rotation angle and the polarity information 180 of the machine tool 200. This eliminates the need of troublesome setting work when setting of the inclined plane coordinate system is performed.

Here, a numerical controller that controls the machine tool 200 without using the coordinate transformation matrix 34 will be described. This numerical controller is a device of a comparative example of the numerical controller 101. When the numerical controller of the comparative example uses a coordinate system setting method assuming the right-handed coordinate system with respect to the left-handed machine tool 200, it is difficult to set the coordinate system because of the following problem. For example, there is a method in which in order to set the coordinate system for the left-handed machine tool 200, the numerical controller of the comparative example assumes a right-handed coordinate system to be a reference and sets the coordinate system while consideration is given to the difference between the right-handed coordinate system and the left-handed coordinate system. With this method, there is no clear criterion to determine which axis should be inverted. Therefore, if there is a linear axis with reversing polarity, it is difficult to know how the polarity of the rotation axis employing an axis with reversed polarity as the rotation center should be set. In addition, there is a problem in that it is troublesome and complicated to perform programming on the left-handed machine tool 200 while assuming the right-handed coordinate system.

Even in a case where the numerical controller of the comparative example sets an inclined plane with no movement and rotation of the coordinate system in the left-handed machine tool 200 in which the X-axis inverts, a coordinate value positioned when an X coordinate is indicated becomes different before and after the inclined plane machining command is issued. That is, even if a move command is issued that causes the machine value to be X10. by the X10. command before the inclined plane machining command, when the X10. command is issued after the inclined plane machining command, the coordinate value is positioned at X−10.; therefore, in order to move the coordinate value to X10. that is a machine value after the inclined plane machining command, it is necessary to issue a command that indicates X−10. In a case where the numerical controller of the comparative example sets an inclined plane with movement or rotation of the coordinate system, it becomes more difficult to understand the behavior of the machine tool 200. As described above, there is a problem in that creating a machining program for the left-handed machine tool 200 while assuming a right-handed machine tool degrades the readability of the machining program and makes it difficult to understand a correspondence relationship between the machining program and the movement direction of the machine tool 200.

Regarding the configuration of the five-axis machine tool 200 that includes two rotation axes, there are tool tilt type, table tilt type, and compound type configurations. By specifying the roll angle, the pitch angle, the yaw angle, and the order of rotation of the coordinate system for such a five-axis machine tool 200, a given inclined plane coordinate system can be set also for the left-handed machine tool 200. However, with such a method for setting the inclined plane coordinate system, since the order of rotation of the coordinates is different for each machine configuration of the machine tool 200, it is necessary to set the coordinate system in consideration of the machine configuration. Therefore, work of setting the coordinate system becomes complicated, which is problematic.

In contrast, since the numerical controller 101 according to the first embodiment sets the coordinate system such as the inclined plane coordinate system using the coordinate transformation matrix 34, it is possible to set a coordinate system corresponding to the machine configuration of the machine tool 200 easily. That is, by specifying the coordinate rotation angle 31 and the origin position 32 without being aware of the axis polarity of the machine tool 200, it is possible to set the coordinate system tailored to the machine tool 200. This facilitates creation of the machining program 150, improves the readability of the machining program 150, and improves the maintainability of the machining program 150.

Since the numerical controller 101 can easily set the coordinate system, it is possible to easily create a basic program using the machine coordinate value 35. The basic program using the machine coordinate value 35 is created before the machining program 150 is created. The machining program 150 is created by using a move command defined in the inclined plane coordinate system as a move command in the basic program. The basic program using the machine coordinate value 35 becomes the machining program 150 by carrying out coordinate transformation corresponding to the inclined plane coordinate system.

As described above, according to the first embodiment, the numerical controller 101 calculates the coordinate transformation matrix 34 using the coordinate rotation angle 31 and the polarity information 180, and sets a coordinate system for coordinate value transformation using the coordinate transformation matrix 34; therefore, it is possible to easily set a coordinate system corresponding to at least one of the movement directions of the linear axes of the machine tool 200 and the rotation directions of the rotation axes 71 to 76 of the machine tool 200. Therefore, even for the left-handed machine tool 200, it is possible to easily set a coordinate system corresponding to the machine configuration. In addition, a command coordinate of the inclined plane coordinate system can be easily transformed into a coordinate value corresponding to the machine configuration of the left-handed machine tool 200.

Since the numerical controller 101 sets the coordinate system using the coordinate transformation matrix 34, the user can create the machining program 150 using the machine coordinate value 35 without discriminating between the right-handed coordinate system and the left-handed coordinate system.

Since the basic program using the machine coordinate value 35 can be easily created, the correspondence between the coordinate values of the machining program 150 and the machine tool 200 can be easily determined by comparing the relationship of the basic program using the machine coordinate value 35 with the coordinate value of the machine tool 200. Therefore, it is possible to easily check whether the machining program 150 can cause the machine tool 200 to execute a desired operation.

### Second Embodiment

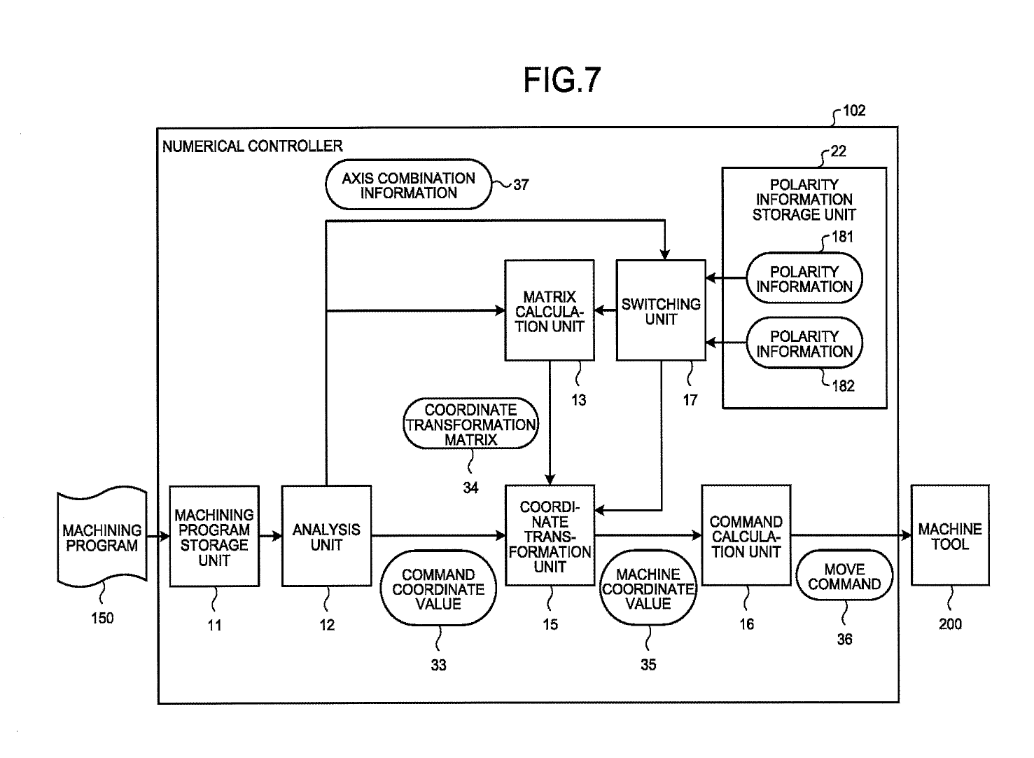

Next, a second embodiment of the present invention will be described with reference to FIGS. 7 to 10. In the second embodiment, multiple pieces of polarity information are switched and used. Hereinafter, a description will focus on the parts different from those in the first embodiment.

In the first embodiment, the coordinate transformation in a case where the machine tool 200 is a five-axis machining center has been described. In the second embodiment, a description will be given of coordinate transformation in a case where the machine tool 200 is an automatic lathe or a lathe. In a case where the machine tool 200 is an automatic lathe or a lathe, a compound type five-axis machine configuration is often employed for the machine tool 200. When the machine tool 200 is a complex lathe, machining is often performed on front and back surfaces using counter spindles.

FIG. 7 is a block diagram illustrating a configuration of a numerical controller according to the second embodiment. Components in FIG. 7 that achieve the same functions as those of the numerical controller 101 of the first embodiment illustrated in FIG. 1 are denoted by the same reference signs and duplicate description is omitted.

A numerical controller 102 of the second embodiment is configured such that a switching unit 17 is added to the numerical controller 101 of the first embodiment. The numerical controller 102 includes a polarity information storage unit 22 instead of the polarity information storage unit 21.

Specifically, the numerical controller 102 includes the machining program storage unit 11, the analysis unit 12, the polarity information storage unit 22, the matrix calculation unit 13, the coordinate transformation unit 15, the command calculation unit 16, and the switching unit 17, which performs switching between polarity information 181 and polarity information 182 to be read on the basis of the combination of axes to be controlled.

In the numerical controller 102, the machining program storage unit 11, the analysis unit 12, the matrix calculation unit 13, the coordinate transformation unit 15, and the command calculation unit 16 are connected in the connection configuration similar to the connection configuration of the numerical controller 101. In the numerical controller 102, the switching unit 17 is connected to the analysis unit 12, the polarity information storage unit 22, the coordinate transformation unit 15, and the matrix calculation unit 13. In FIG. 7, illustration of the coordinate rotation angle 31 and the origin position 32 is omitted.

The polarity information storage unit 22 is a storage device such as a memory that stores the polarity information 181, which is first polarity information, and the polarity information 182, which is second polarity information. The switching unit 17, which is a selection unit, selects and reads the polarity information 181 or the polarity information 182, and outputs the selected and read polarity information to the matrix calculation unit 13.

In addition to the functions described in the first embodiment, the analysis unit 12 in the second embodiment has a function of outputting axis combination information 37 described in the machining program 150 to the switching unit 17. That is, the analysis unit 12 extracts the axis combination information 37 and outputs the extracted axis combination information 37 to the switching unit 17 on the basis of the machining program 150.

The axis combination information 37 is information indicating a combination of axes used in the machine tool 200. The machine tool 200 machines workpieces 67 and 68 described later with various axis combinations defined in the machining program 150. For example, a first axis combination is used in a first block range in the machining program 150, and a second axis combination is used in a second block range in the machining program 150.

The switching unit 17 is configured such that switching can be performed between the polarity information 181 and the polarity information 182 by selecting and outputting one piece of polarity information out of the polarity information 181 and 182 in accordance with the combination of five axes to be controlled of the machine tool 200. In other words, the switching unit 17 selects specific polarity information corresponding to the operation of the machine tool 200 from the polarity information 181 and 182. Specifically, the switching unit 17 selects polarity information that is in accordance with the configuration of the axis to be used, on the basis of the axis combination information 37, which is the output result of the analysis unit 12. The switching unit 17 selects the polarity information 181 or the polarity information 182 from the polarity information storage unit 22, and outputs the selected polarity information to the coordinate transformation unit 15 and the matrix calculation unit 13. In the second embodiment, a description will be given of the case where two pieces of polarity information 181 and 182 are used; however, the number of pieces of polarity information may be three or more.

The switching unit 17 selects and reads the polarity information 181 when the combination of axes used by the machine tool 200 is the first axis combination. The switching unit 17 selects and reads the polarity information 182 when the combination of axes used by the machine tool 200 is the second axis combination. Then, the switching unit 17 outputs the read polarity information 181 or 182 to the matrix calculation unit 13. As a result, the switching unit 17 switches polarity information used for calculation of the coordinate system to the polarity information 181 or the polarity information 182.

The matrix calculation unit 13, the coordinate transformation unit 15, and the command calculation unit 16 perform processes similar to those in the first embodiment. As a result, the numerical controller 102 calculates the machine coordinate value 35 after acceleration/deceleration, and outputs the move command 36 corresponding to the machine coordinate value 35 to the machine tool 200, which is a machine drive unit.

In the second embodiment, the numerical controller 102 controls the machine tool 200 by using a second machining program, which is a second example of the machining program 150. The second machining program is described as follows.

### <Second Machining Program>

### N10 G54 G0X10.Y10.Z0.

### N11 G68.2P5X0.Y0.Z0.I0.J45.K0. D2

### N12 G53.1

### N13 G1 X10. F1000.

### N14 G1 Y10.Z0.

### N15 G1 Z5.

### N20 G69

:
:

In the second machining program, in the N10 block, the G54 command specifies a coordinate system to be used, and the rapid traverse command G0 is a command to move a tool 91 described later to the position of (X,Y,Z)=(10,10,0) in the G54 coordinate system.

In the N11 block, a command is added that enables specification of a combination of axes constituting five axes. Specifically, in the second machining program, a D address is added to the G68.2 command in the N11 block, thereby enabling the group number of the polarity information 181 and 182 to be selected with the D address. As a result, the second machining program can select one of the multiple pieces of polarity information 181 and 182 stored in advance. The configuration after the N12 block in the second machining program is similar to the configuration after the N12 block in the first machining program. For convenience of description, coordinate values after the N13 block are set to values different from those of the first machining program.

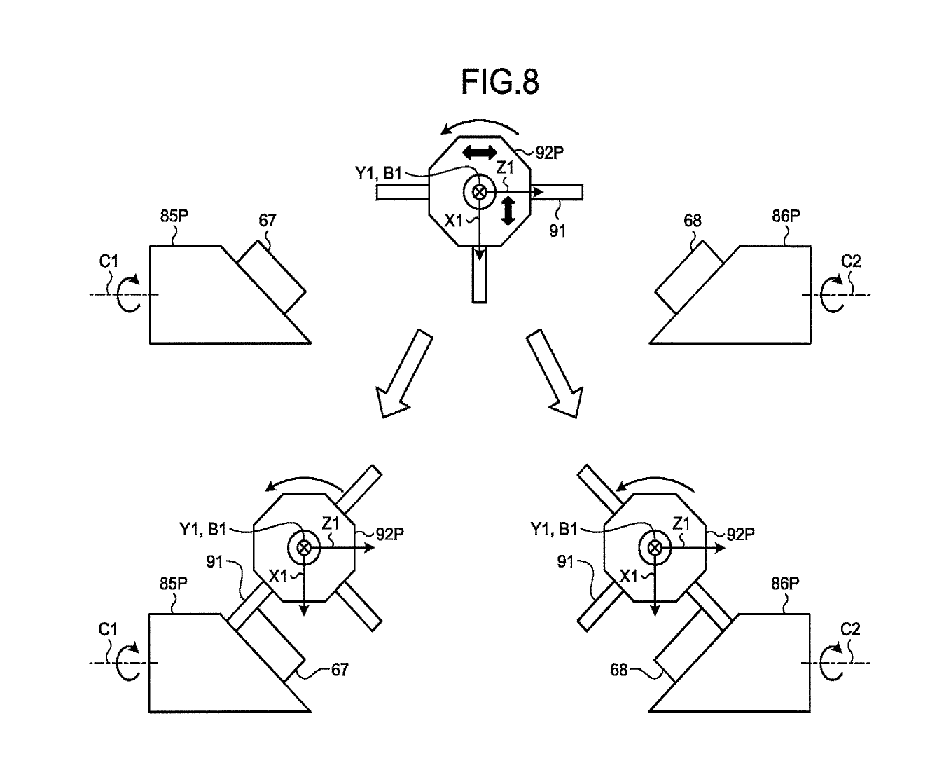

Examples of the machine tool 200 to which the multiple pieces of polarity information 181 and 182 are applied include a spindle fixed type machine tool and a spindle moving type machine tool. FIG. 8 is a diagram for explaining a machine configuration of a spindle fixed type machine tool according to the second embodiment. The spindle fixed type machine tool, which is a compound type machine, is an example of the machine tool 200 and includes a rotatable tool base 92P and rotary tables 85P and 86P.

An example of the tool base 92P, which is a cutting tool base, is a turret. The tool base 92P is a base for holding the tool 91 such as a turret tool. The tool base 92P is configured such that a plurality of tools 91 can be held. FIG. 8 illustrates a case where the tool base 92P holds three tools 91. The tool 91 is a cutting tool that cuts the workpieces 67 and 68 by rotating about the tool axis.

The tool base 92P is rotatable about an Y1-axis and can translate in axial directions of an X1-axis, the Y1-axis, and a Z1-axis. As seen from the above, the tool base 92P includes a tool rotation axis that is a B1-axis and translation axes that are the X1-axis, the Y1-axis, and the Z1-axis. With such a configuration, the tool 91 can move in the X1-axis direction, the Y1-axis direction, and the Z1-axis direction, and rotate about the Y1-axis within an XZ plane. FIG. 8 illustrates arrows indicating translation in the axial directions of the X1-axis and the Z1-axis but does not illustrate an arrow indicating translation in the axial direction of the Y1-axis.

The rotary table 85P holds the workpiece 67 and the rotary table 86P holds the workpiece 68. The rotary tables 85P and 86P are rotatable about the Z-axis. The rotary table 85P rotates about a C1-axis and the rotary table 86P rotates about a C2-axis.

As a result, the tool base 92P is configured such that the workpiece 67 set on the rotary table 85P or the workpiece 68 set on the rotary table 86P can be machined. In FIG. 8, machining of the workpiece 67 by the tool 91 corresponds to front surface machining and machining of the workpiece 68 by the tool 91 corresponds to back surface machining. As illustrated in FIG. 8, in the spindle fixed type machine tool, the rotation direction of the tool base 92P is of opposite polarity to the Y1-axis.

When the workpiece 67 is machined, the tool base 92P translates in the axial directions of the X1-axis, the Y1-axis, and the Z1-axis, and the tool base 92P rotates in the B1-axis direction, whereby the tool 91 moves to the front surface of the workpiece 67. FIG. 8 illustrates a state where the tool 91 is in contact with the workpiece 67 as a result of the rotation of the tool base 92P by B+45 deg in the B1-axis direction. While the tool 91 and the workpiece 67 are in contact with each other in the above state, the rotary table 85P rotates about the C1-axis and the tool 91 rotates about the tool axis, whereby the tool 91 machines the workpiece 67.

In a similar manner, when the workpiece 68 is machined, the tool base 92P translates in the axial directions of the X1-axis, the Y1-axis, and the Z1-axis, and the tool base 92P rotates in the B1-axis direction, whereby the tool 91 moves to the back surface of the workpiece 68. FIG. 8 illustrates a state where the tool 91 is in contact with the workpiece 68 as a result of the rotation of the tool base 92P by B−45 deg in the B1-axis direction. While the tool 91 and the workpiece 69 are in contact with each other in the above state, the rotary table 86P rotates about the C2-axis and the tool 91 rotates about the tool axis, whereby the tool 91 machines the workpiece 68.

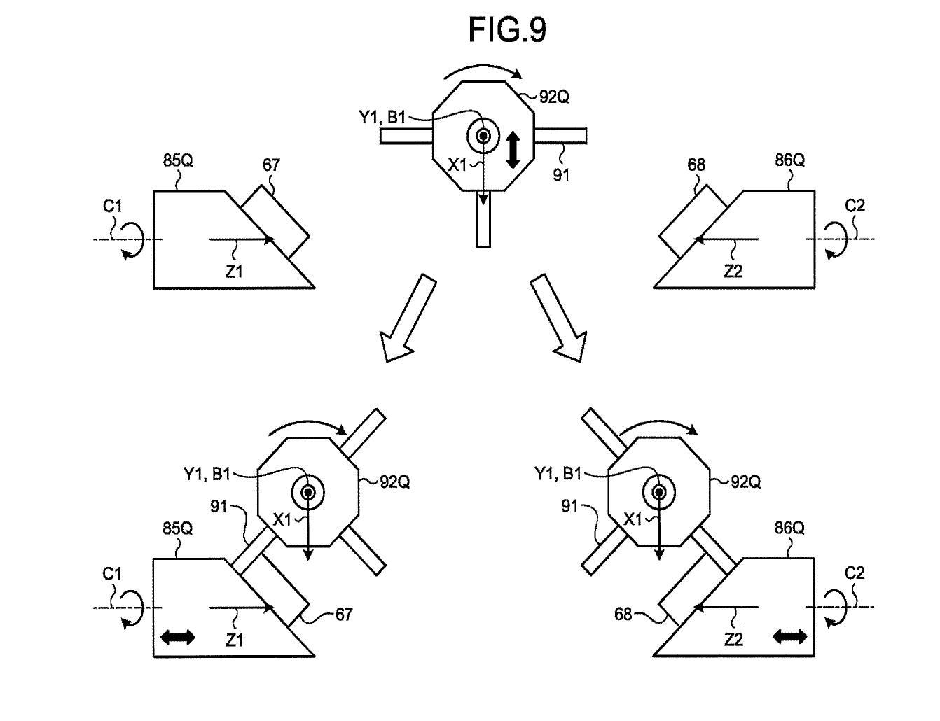

FIG. 9 is a diagram for explaining a machine configuration of a spindle moving type machine tool according to the second embodiment. The spindle moving type machine tool, which is a compound type machine, is an example of the machine tool 200 and includes a rotatable tool base 92Q and rotary tables 85Q and 86Q.

An example of the tool base 92Q, which is a cutting tool base, is a turret. The tool base 92Q is a base for holding the tool 91. The tool base 92Q is configured such that a plurality of tools 91 can be held. FIG. 9 illustrates a case where the tool base 92Q holds three tools 91. The tool 91 is a cutting tool that cuts the workpieces 67 and 68 by rotating about the tool axis.

The tool base 92Q is rotatable about the Y1-axis and can translate in axial directions of the X1-axis and the Y1-axis. As seen from the above, the tool base 92Q includes a tool rotation axis that is the B1-axis and translation axes that are the X1-axis and the Y1-axis. With such a configuration, the tool 91 can move in the X1-axis direction and in the Y1-axis direction, and rotate about the Y1-axis within the XZ plane. FIG. 9 illustrates arrows indicating translation in the axial directions of the X1-axis, the Z1-axis, and a Z2-axis but does not illustrate an arrow indicating translation in the axial direction of the Y1-axis.

The rotary table 85Q holds the workpiece 67 and the rotary table 86Q holds the workpiece 68. The rotary tables 85Q and 86Q are rotatable about the Z-axis. The rotary table 85Q is rotatable about the C1-axis and the rotary table 86Q is rotatable about the C2-axis. The rotary table 85Q can translate in the Z1-axis direction and the rotary table 86Q can translate in a Z2-axis direction.

As a result, the tool base 92Q is configured such that the workpiece 67 set on the rotary table 85Q or the workpiece 68 set on the rotary table 86Q can be machined. In FIG. 9, machining of the workpiece 67 by the tool 91 corresponds to front surface machining and machining of the workpiece 68 by the tool 91 corresponds to back surface machining. As described above, the spindle moving type machine tool illustrated in FIG. 9 has a machine configuration in which the polarity of the Z-axis, which is a linear axis, is reversed depending on which of the rotary table 85Q or the rotary table 86Q is used for machining.

In the spindle moving type machine tool illustrated in FIG. 9, the tool 91 does not move in the Z-axis direction, but the workpiece 67 and the workpiece 68 move in the Z1-axis direction and the Z2-axis direction, respectively. That is, the spindle moving type machine tool illustrated in FIG. 9 has a machine configuration in which the direction in which the workpieces 67 and 68 and the tool 91 approach each other corresponds to the positive Z-axis direction.

With such a relative relationship between the tool 91 and the workpieces 67 and 68, the spindle moving type machine tool illustrated in FIG. 9 can be regarded as the machine tool 200 in which the direction in which the tool 91 approaches the workpieces 67 and 68 is the positive direction when the workpieces 67 and 68 are fixed. In the spindle moving type machine tool illustrated in FIG. 9, linear axes in a case of performing the front surface machining have a right-handed configuration.

When the workpiece 67 is machined, the tool base 92Q translates in the axial directions of the X1-axis and the Y1-axis, the tool base 92Q rotates in the B1-axis direction, and the rotary table 85Q translates in the Z1-axis direction, whereby the tool 91 moves to the front surface of the workpiece 67. FIG. 9 illustrates a state where the tool 91 is in contact with the workpiece 67 as a result of the rotation of the tool base 92Q by B−45 deg in the B1-axis direction. While the tool 91 and the workpiece 67 are in contact with each other in the above state, the rotary table 85Q rotates about the C1-axis and the tool 91 rotates about the tool axis, whereby the tool 91 machines the workpiece 67.

In a similar manner, when the workpiece 68 is machined, the tool base 92Q translates in the axial directions of the X1-axis and the Y1-axis, the tool base 92Q rotates in the B1-axis direction, and the rotary table 86Q translates in the Z2-axis direction, whereby the tool 91 moves to the back surface of the workpiece 68. FIG. 9 illustrates a state where the tool 91 is in contact with the workpiece 68 as a result of the rotation of the tool base 92Q by B+45 deg in the B1-axis direction. While the tool 91 and the workpiece 68 are in contact with each other in the above state, the rotary table 86Q rotates about the C2-axis and the tool 91 rotates about the tool axis, whereby the tool 91 machines the workpiece 68.

As illustrated in FIG. 9, with the machine configuration in which the workpieces 67 and 68 move in the Z-axis direction, the Z-axis direction with respect to the tool 91 such as a turret tool during the front surface machining is reversed from that during the back surface machining, and accordingly, the coordinate axis direction is different for the front surface machining and the back surface machining. For this reason, in the spindle moving type machine tool illustrated in FIG. 9, it is necessary to perform switching between the polarity information 181 and the polarity information 182 depending on whether it is a case of the front surface machining or the back surface machining.

The machine tools 200 having the machine configurations illustrated in FIG. 8 and FIG. 9 are each a machine tool that needs to change the setting of the polarity depending on the configuration of the axes to be combined even though it is a single machine tool. Therefore, the numerical controller 102 performs switching between the polarity information 181 and the polarity information 182 depending on whether it is a case of machining using the rotary tables 85P and 85Q or a case of machining using the rotary tables 86P and 86Q.

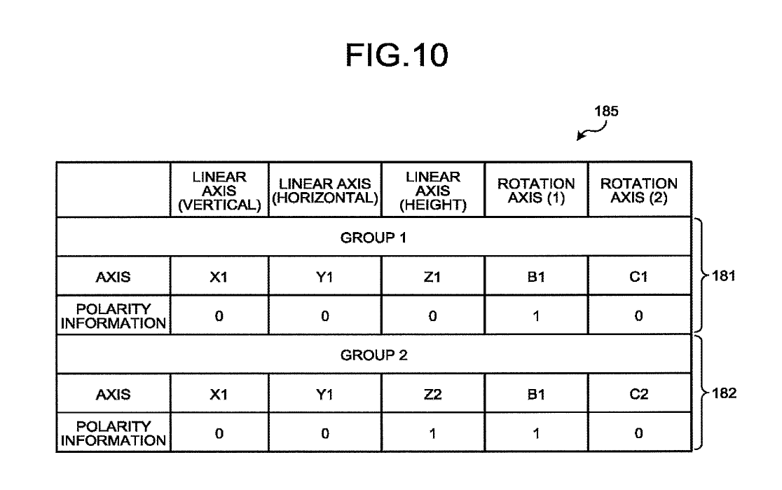

Here, the configuration of the polarity information 181 and 182 will be described. FIG. 10 is a diagram illustrating the configuration of a polarity information table according to the second embodiment. The polarity information table 185 is configured to include the polarity information 181 and 182. In FIG. 10, polarity information in a group 1 corresponds to the polarity information 181, and polarity information in a group 2 corresponds to the polarity information 182.

In the polarity information 181 in the group 1, pieces of the polarity information “0”, “0”, “0”, “1”, and “0” are associated with the X1-axis that is a linear axis in a vertical direction, the Y1-axis that is a linear axis in a horizontal direction, the Z1-axis that is a linear axis in a height direction, the B1-axis that is a first rotation axis, and the C1-axis that is a second rotation axis, respectively. In the polarity information 182 in the group 2, pieces of polarity information “0”, “0”, “1”, “1”, “0” are associated with the X1-axis, the Y1-axis, the Z2-axis, the B1-axis, and the C2-axis, respectively. Here, the polarity information “0” indicates an axis in accordance with the right-handed coordinate system, and the polarity information “1” indicates an axis in accordance with the left-handed coordinate system.

When executing machining using the rotary table 85Q, the numerical controller 102 uses the polarity information 181 in the group 1 illustrated in FIG. 10. When executing machining using the rotary table 86Q, the numerical controller 102 uses the polarity information 182 in the group 2 illustrated in FIG. 10. As described above, the numerical controller 102 controls machining while performing switching between the polarity information 181 and the polarity information 182, for one machine tool.

In the case of the spindle moving type machine tool illustrated in FIG. 9, in the back surface machining using the Z2-axis, a machine configuration is employed in which the combination of the linear axes is not in accordance with the right-handed coordinate system. In that case, it is necessary to treat the linear axes as a left-handed machine configuration. Hereinafter, processes of the matrix calculation unit 13 and the coordinate transformation unit 15 will be described using, as an example, a case where the machine configuration is the left-handed coordinate system of a Z-axis inversion type. Since the origin position 32 of the inclined plane coordinate system in the second embodiment can be set in the G54 coordinate system, it is possible to set the inclined plane coordinate system easily by placing values of the coordinate axes irrespective of whether it is the right-handed configuration or the left-handed configuration. Since a command value by the second machining program during the machining of the inclined plane is a command based on the machine coordinate value 35 of the machine tool 200, the relationship between the motion or the coordinate value of the machine tool 200 and the coordinate value of the second machining program is clear. As a result, a user can easily create the second machining program.

The coordinate transformation unit 15 in the second embodiment calculates the coordinate value of the machine tool 200 using the following formula (11) when the coordinate values (X,Y,Z)=(10,0,0) of the X-axis, the Y-axis, and the Z-axis described in the second machining program are input as a command position.

$$\begin{matrix}[ Formula 11 ] & \\ \begin{matrix}T = [ \begin{matrix}{K}_{XYZ} Rot ( {r}_{Y} , {k}_{B} \times β ) {K}_{XYZ} & p \\ 0 & 1\end{matrix} ] \\ {K}_{XYZ} = [ \begin{matrix}{k}_{X} & 0 & 0 \\ 0 & {k}_{Y} & 0 \\ 0 & 0 & {k}_{Z}\end{matrix} ]\end{matrix} \} & ( 11 )\end{matrix}$$

When the B-axis has reverse polarity, the matrix calculation unit 13 calculates the coordinate transformation matrix 34 by using the above-described formula (8). In the polarity information 182 illustrated in FIG. 10, since the polarity information on the Z2-axis in the group 2 is “1”, the machine tool 200 is the left-handed coordinate system of a Z-axis inversion type. If the origin position 32 of the inclined plane coordinate system is (X,Y,Z)=(0,0,0), the following formula (12) is obtained from the formula (11).

$$\begin{matrix} [ Formula 12 ] & \\ [ \begin{matrix}1 & 0 & 0 \\ 0 & 1 & 0 \\ 0 & 0 & - 1\end{matrix} ] [ \begin{matrix}cos β & 0 & - sin β \\ 0 & 1 & 0 \\ sin β & 0 & cos β\end{matrix} ] [ \begin{matrix}1 & 0 & 0 \\ 0 & 1 & 0 \\ 0 & 0 & - 1\end{matrix} ] [ \begin{matrix}10. \\ 0. \\ 0.\end{matrix} ] = [ \begin{matrix}1 & 0 & 0 \\ 0 & 1 & 0 \\ 0 & 0 & - 1\end{matrix} ] [ \begin{matrix}\frac{10}{\sqrt{2}} \\ 0. \\ \frac{10}{\sqrt{2}}\end{matrix} ] = [ \begin{matrix}7.071 \\ 0. \\ - 7.071\end{matrix} ] & ( 12 )\end{matrix}$$

Here, a third machining program as a third example of the machining program 150 will be described. The third machining program is described as follows.

### <Third Machining Program>

### N10 G54 G0X10.Y10.Z0.

### N11 G68.2P5X0.Y0.Z0.I0.J0.K0. D2

### N12 G53.1

### N13 G1 X10. F1000.

### N14 G1 Z0.

### N20 G69

:
:

In the third machining program, the tool 91 is positioned at (X1,Y1,Z2)=(10,10,0) in the G54 coordinate system by the G54 command of the N10 block, and the command of X10. is issued again in the N13 block. Since coordinate values described in the third machining program are set so as to be in accordance with the coordinate system before the inclined plane coordinate system is defined, if the G54 coordinate system that is the coordinate system before the inclined plane machining is defined has the left-handed machine configuration, axial movement in the left-handed coordinate system is described in the coordinate values of the third machining program.

The G68.2 command of the N11 block in the third machining program makes the coordinate system to coincide with the G54 coordinate system, and in the command of the N13 block, positioning is performed so as to obtain the same coordinate value as that in the N10 block. Thus, all the coordinate values before and after the inclined plane coordinate system is defined can be unified to the coordinate system of the machine tool 200. Therefore, the user can use a consistent coordinate system throughout the third machining program.

This makes it possible to eliminate the discontinuity of the coordinate values that occurs when the right-handed third machining program is used for the left-handed machine tool 200 only during the machining of the inclined plane. Therefore, the numerical controller 102 can drive the machine tool 200 without the readability of the third machining program being degraded. In addition, the maintainability of the third machining program is improved.

As described above, according to the second embodiment, since the numerical controller 102 includes the switching unit 17, the numerical controller 102 can perform switching between the polarity information 181 and the polarity information 182 at necessary timing even in a case where a single machine tool 200 has a plurality of combinations of five axes. As a result, the numerical controller 102 can specify the coordinate system that uses appropriate polarity information, and therefore, even if a configuration of related axes changes at the timing of performing back surface machining after front surface machining, it is possible to control the machine tool 200 easily.

### Third Embodiment

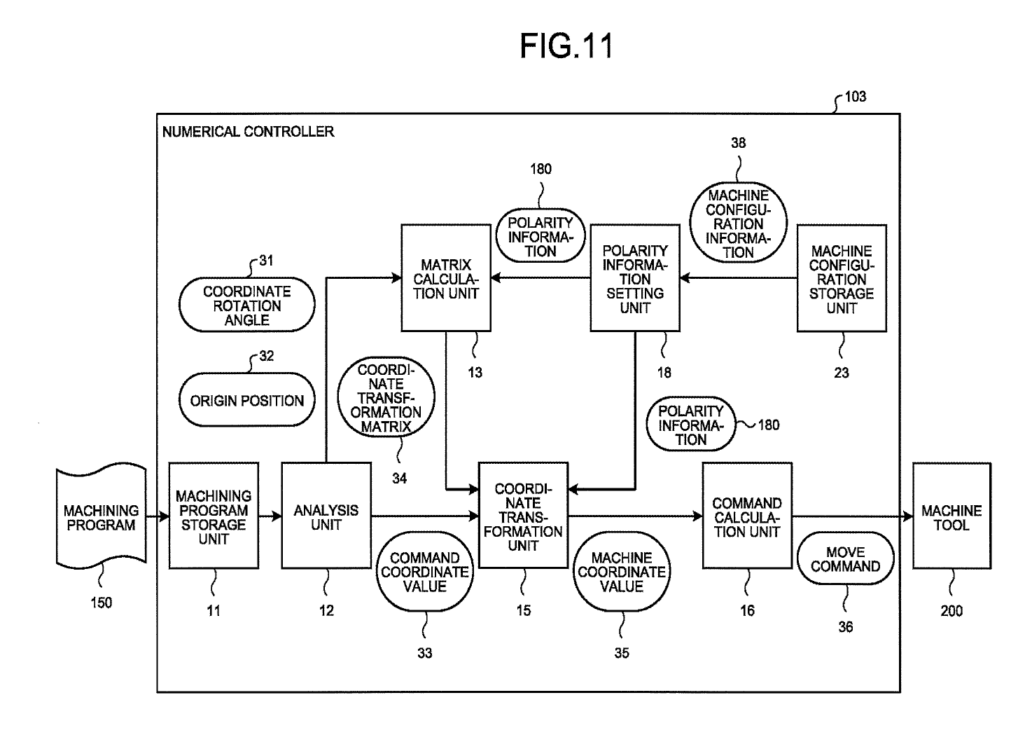

Next, a third embodiment of the present invention will be described with reference to FIGS. 11 to 14. In the third embodiment, on the basis of the machine configuration of the machine tool 200, a numerical controller 103 described later creates the polarity information 180 used in the first embodiment. The numerical controller 103 may create the polarity information 181 and 182 used in the second embodiment. Hereinafter, a description will focus on the parts different from those in the first and second embodiments.

FIG. 11 is a block diagram illustrating a configuration of the numerical controller according to the third embodiment. Components in FIG. 11 that achieve the same functions as those of the numerical controller 101 of the first embodiment illustrated in FIG. 1 are denoted by the same reference signs and duplicate description is omitted.

The numerical controller 103 of the third embodiment is configured such that a machine configuration storage unit 23 and a polarity information setting unit 18 are added to the numerical controller 101 of the first embodiment. Specifically, the numerical controller 103 includes the machining program storage unit 11, the analysis unit 12, the matrix calculation unit 13, the coordinate transformation unit 15, the command calculation unit 16, and the machine configuration storage unit 23 that stores machine configuration information 38, and the polarity information setting unit 18 that sets the polarity information 180 on the basis of the machine configuration information 38. The machine configuration information 38 is information on the machine configuration of the machine tool 200. The machine configuration information 38 includes information on the types of axes of the machine tool 200. Specifically, the machine configuration information 38 includes at least one of the axial directions of the linear axes of the machine tool 200 and the rotation directions of the rotation axes thereof.

In the numerical controller 103, the machining program storage unit 11, the analysis unit 12, the matrix calculation unit 13, the coordinate transformation unit 15, and the command calculation unit 16 are connected in the connection configuration similar to the connection configuration of the numerical controller 101. In the numerical controller 103, the polarity information setting unit 18 is connected to the machine configuration storage unit 23, the coordinate transformation unit 15, and the matrix calculation unit 13.

The machine configuration storage unit 23 is a storage device such as a memory that stores the machine configuration information 38. The polarity information setting unit 18, which is a setting unit, sets the polarity information 180 on the basis of the machine configuration information 38 and outputs the set polarity information 180 to the matrix calculation unit 13 and the coordinate transformation unit 15. The polarity information setting unit 18 sets the polarity information on the linear axes described later, and then sets the polarity information on the rotation axes described later.

When the coordinate axes of the machine tool 200 are of the left-handed coordinate system, there are a plurality of right-handed coordinate systems assumed for the left-handed coordinate system. Here, candidates for reference right-handed coordinate systems for the left-handed coordinate system will be described. The reference right-handed coordinate systems are right-handed coordinate systems from which the left-handed coordinate system is calculated. In other words, the right-handed coordinate systems serving as a base for calculating the left-handed coordinate system are the reference right-handed coordinate systems.

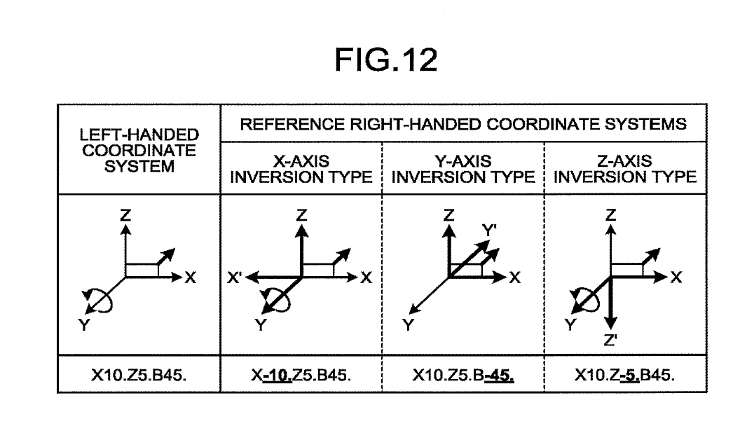

FIG. 12 is a diagram for explaining the relationship between the left-handed coordinate system and the reference right-handed coordinate systems according to the third embodiment. FIG. 12 illustrates an example of the left-handed coordinate system, and the reference right-handed coordinate systems assumed for the left-handed coordinate system.

For the left-handed coordinate system, a total of three reference right-handed coordinate systems of the X-axis inversion type, the Y-axis inversion type, and the Z-axis inversion type can be considered as axis inversion types. FIG. 12 illustrates the left-handed coordinate system in a case where the command is X10.Z5.B45. In the X-axis inverted reference right-handed coordinate system, the Y-axis inverted reference right-handed coordinate system, and the Z-axis inverted reference right-handed coordinate system corresponding to this left-handed coordinate system, the commands are X−10.Z5.B45., X10.Z5.B−45., and X10.Z−5.B45., respectively.

The numerical controller 103, which uses the machining program 150, selects the polarity information 180 to be set for each combination of axes of the machine tool 200 on the basis of which type of reference right-handed coordinate systems the polarity information 180 corresponds to.

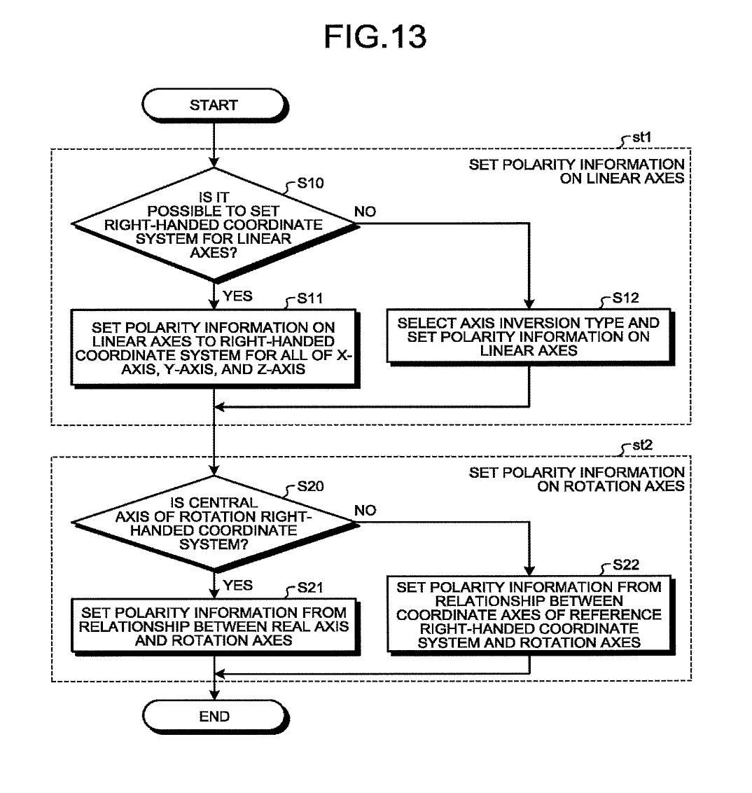

Here, a setting process of the polarity information 180 by the numerical controller 103 will be described. FIG. 13 is a flowchart illustrating a setting processing procedure of the polarity information according to the third embodiment. The numerical controller 103 executes a process roughly divided into two steps. In Step st1, the numerical controller 103 sets the polarity information on the linear axes in the polarity information 180, and then, in Step st2, sets the polarity information on the rotation axes in the polarity information 180. The process of Step st1 includes the processes of Steps S10 to S12, and the process of Step st2 includes the processes of Steps S20 to S22.

Details of the process of Step st1 and the process of Step st2 will be described below. In the numerical controller 103, the machine configuration storage unit 23 stores the machine configuration information 38 in advance. Then, the polarity information setting unit 18 reads the machine configuration information 38 from the machine configuration storage unit 23. Thereafter, on the basis of the machine configuration information 38, the polarity information setting unit 18 executes the processes of Steps S10 to S12, which are the process of Step st1, and the processes of Steps S20 to S22, which are the process of Step st2.

Specifically, in Step S10 of Step st1, the polarity information setting unit 18 determines whether it is possible to set the right-handed coordinate system for the linear axes. That is, regarding three linear axes, the polarity information setting unit 18 determines whether the right-handed coordinate system can be set for the three axes.

If the polarity information setting unit 18 determines that the right-handed coordinate system can be set, that is, if Yes is determined in Step S10, the polarity information setting unit 18 executes the process of Step S11. In Step S11, the polarity information setting unit 18 sets the polarity information on the linear axes to the right-handed coordinate system for all of the X-axis, the Y-axis, and the Z-axis.

In contrast, if the polarity information setting unit 18 determines that the right-handed coordinate system cannot be set, that is, if No is determined in Step S10, the polarity information setting unit 18 executes the process of Step S12. In Step S12, the polarity information setting unit 18 selects an axis inversion type and sets the polarity information on the linear axes. The axis inversion type is any one of the X-axis inverted reference right-handed coordinate system, the Y-axis inverted reference right-handed coordinate system, and the Z-axis inverted reference right-handed coordinate system. The polarity information setting unit 18 selects one axis inversion type from these axis inversion types and sets the polarity information on the linear axes. The polarity information setting unit 18 selects the axis inversion type in accordance with the following rules.

### <Rule 1>

Select an axis that is not the central axis of rotation from among the X-axis, the Y-axis and the Z-axis. In that case, the polarity information setting unit 18 selects the X-axis in a case where the machine configuration includes the B-axis and the C-axis, and selects the Y-axis in a case where the machine configuration includes the A-axis and the C-axis, thereby selecting an axis that is not the central axis of rotation.

### <Rule 2>

Set the polarity information on the axis selected in the rule 1 to the coordinate axis of the left-handed coordinate system.

### <Rule 3>

Set the polarity information on each of the remaining two linear axes to the coordinate axis of the right-handed coordinate system.

The polarity information setting unit 18 may freely select the axis inversion type in accordance with an instruction from a user without adopting the above rules. After executing the process of Step S11 or Step S12, the polarity information setting unit 18 executes the process of Step st2.

Specifically, in Step S20 of Step st2, the polarity information setting unit 18 determines whether the central axis of rotation is the right-handed coordinate system. That is, the polarity information setting unit 18 determines whether the central axis of rotation, which is the rotation center of each rotation axis, is set to the right-handed coordinate system in the process of Step st1, with respect to the two rotation axes.

If the polarity information setting unit 18 determines that the central axis of rotation is the right-handed coordinate system, that is, if Yes is determined in Step 320, the polarity information setting unit 18 executes the process of Step S21. That is, the polarity information setting unit 18 executes the process of Step S21 that is the process of setting the polarity information 180 with respect to the axis whose central axis of rotation of the rotation axis is the right-handed coordinate system.

In Step S21, the polarity information setting unit 18 sets the polarity information 180 on the basis of the relationship between a real axis that is an actual axis and the rotation axes. When the polarity information setting unit 18 sets the polarity information on the linear axes in accordance with the rules used in Step S12, the central axis of rotation is always the right-handed linear axis, and therefore, the process does not proceed to Step S22. In Step S21, if the right screw direction with respect to the linear axis of the right-handed coordinate system is the same as the rotation direction of the rotation axis, the polarity information setting unit 18 determines that it is the right-handed coordinate system and sets the right-handed coordinate system as the polarity information on the rotation axis. When the right screw direction with respect to the linear axis of the right-handed coordinate system and the rotation direction of the rotation axis do not coincide with each other, the polarity information setting unit 18 sets the left-handed coordinate system as the polarity information on the rotation axis.

In contrast, if the polarity information setting unit 18 determines that it is not the right-handed coordinate system, that is, if No is determined in Step S20, the polarity information setting unit 18 executes the process of Step S22. The process of Step S22 is a process when the central axis of rotation of the rotation axis is not the right-handed coordinate system.

When the polarity information setting unit 18 sets the polarity information on the linear axes by the method different from the rules 1 to 3 in the process of the Step S12 described above, there may be a case where an axis for which the left-handed coordinate system is set as the polarity information on the rotation axis becomes the central axis of rotation. In such a case, the process of Step S22 is performed. In Step S22, the polarity information setting unit 18 sets the polarity information on the rotation axes on the basis of the relationship between the coordinate axes of the reference right-handed coordinate system and the rotation axes. Therefore, the polarity information setting unit 18 determines whether the relationship between the coordinate axes of the reference right-handed coordinate system and the rotation axes indicates the right-handed coordinate system, and then sets the polarity information on the rotation axes. When the relationship between the coordinate axes of the reference right-handed coordinate system and the rotation axes indicates the right-handed coordinate system, the polarity information setting unit 18 sets the right-handed coordinate system as the polarity information on the rotation axes. When the relationship between the coordinate axes of the reference right-handed coordinate system and the rotation axes indicates the left-handed coordinate system, the polarity information setting unit 18 sets the right-handed coordinate system as the polarity information on the rotation axes.

With respect to the rotation axis of the tool 25, it is sufficient to determine whether it is the right-handed coordinate system by comparing the right screw direction with respect to the linear axes and the rotation direction. However, with respect to the rotation axis of the tables 81 to 83, attention should be paid to the fact that the rotation direction is opposite, i.e. the left screw direction.

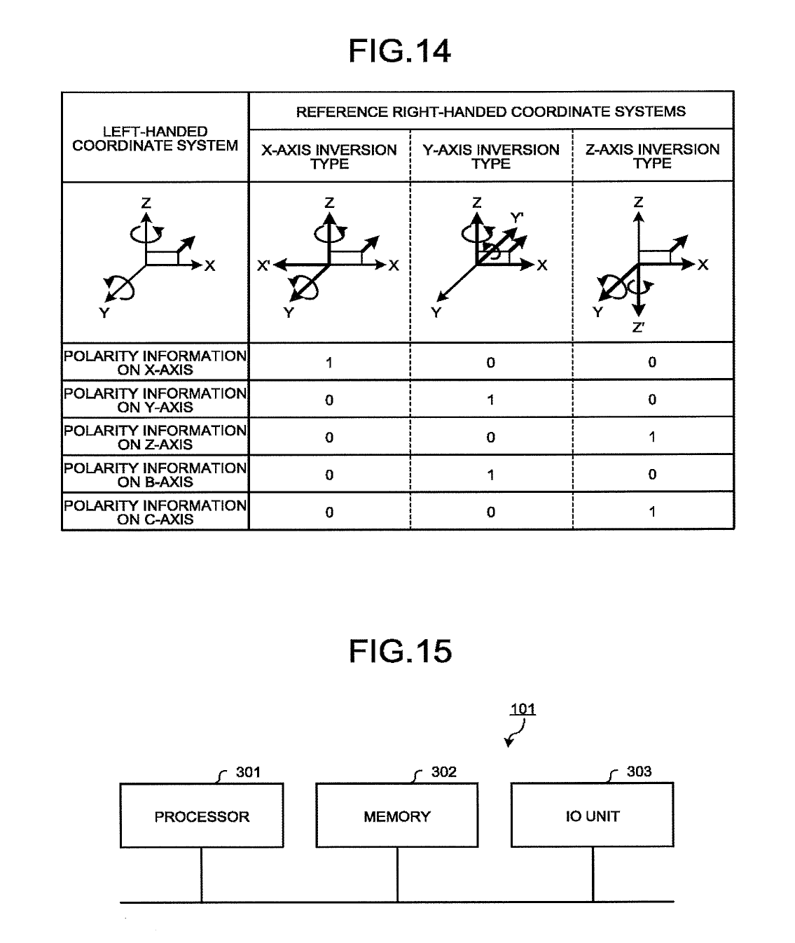

Here, setting examples of the polarity information 180 for the types of the reference right-handed coordinate systems will be described. FIG. 14 is a diagram illustrating the setting examples of the polarity information according to the third embodiment. The example of the left-handed coordinate system and the examples of the reference right-handed coordinate system assumed for the left-handed coordinate system illustrated in FIG. 14 are similar to those illustrated in FIG. 12. Therefore, the polarity information setting unit 18 sets different polarity information 180 for each reference right-handed coordinate system. Thus, there are a plurality of setting patterns of polarity information 180 for one left-handed coordinate system. The polarity information 180 includes polarity information on the X-axis, polarity information on the Y-axis, polarity information on the Z-axis, polarity information on the B-axis, and polarity information on the C-axis. Here, the polarity information on each axis being “0” indicates that the axis is in accordance with the right-handed coordinate system, and the polarity information on each axis being “1” indicates that the axis is in accordance with the left-handed coordinate system.

For the X-axis inverted reference right-handed coordinate system, the polarity information setting unit 18 sets “1”, “0”, “0”, “0”, and “0” as the polarity information on the X-axis, the Y-axis, the Z-axis, the B-axis, and the C-axis, respectively.

For the Y-axis inverted reference right-handed coordinate system, the polarity information setting unit 18 sets “0”, “1”, “0”, “1”, and “0” as the polarity information on the X-axis, the Y-axis, the Z-axis, the B-axis, and the C-axis, respectively.

For the Z-axis inverted reference right-handed coordinate system, the polarity information setting unit 18 sets “0”, “0”, “1”, “0”, and “1” as the polarity information on the X-axis, the Y-axis, the Z-axis, the B-axis, and the C-axis, respectively.

In the case of the left-handed coordinate system illustrated in FIG. 14, the polarity information setting unit 18 can reduce the number of left-handed axes having reverse polarity by selecting the X-axis inverted reference right-handed coordinate system. The polarity information setting unit 18 does not have to comply with specific rules when setting the polarity information on the linear axes. For example, the polarity information setting unit 18 can easily set the polarity information 180 by using the method of Step S12 described above.

The polarity information setting unit 18 can obtain the same machining result regardless of the types of the polarity information 180 used, the types being the X-axis inversion type, Y-axis inversion type, and Z-axis inversion type illustrated in FIG. 14. This can be confirmed from the fact that machining results coincide with each other by using the formula (11) described above.

As described above, according to the third embodiment, since the polarity information setting unit 18 sets the polarity information on the rotation axes after setting the polarity information on the linear axes, it is possible to set the polarity information 180 easily.

Here, a hardware configuration of the numerical controllers 101 to 103 will be described. FIG. 15 is a diagram illustrating the exemplary hardware configuration of the numerical controllers according to the first to third embodiments. Since the numerical controllers 101 to 103 have similar hardware configurations, the hardware configuration of the numerical controller 101 will be described here.

The numerical controller 101 can be achieved by a processor 301, a memory 302, and an Input Output (IO) unit 303. The machining program storage unit 11 and the polarity information storage unit 21 correspond to the memory 302, and the analysis unit 12, the matrix calculation unit 13, the coordinate transformation unit 15, and the command calculation unit 16 are achieved by the processor 301 executing a program stored in the memory 302.

Examples of the processor 301 include a Central Processing Unit (CPU, also referred to as central processor, processing device, arithmetic device, microprocessor, microcomputer, and DSP) and system Large Scale Integration (LSI). Examples of the memory 302 include a Random Access Memory (RAM) and a Read Only Memory (ROM).

The numerical controller 101 is achieved by the processor 301 reading a program for executing an operation of the numerical controller 101 from the memory 302 and executing the program. The memory 302 is also used as a temporary memory when the processor 301 executes various processes.

The program executed by the processor 301 may be achieved as a computer program product that is a recording medium having a program stored therein. An example of the recording medium in that case is a non-transitory computer readable medium having a program stored therein.

The numerical controller 101 may be achieved by dedicated hardware. Some of the functions of the numerical controller 101 may be achieved by dedicated hardware and the remaining functions may be achieved by software or firmware.

The configuration described in each embodiment above indicates one example of the content of the present invention and can be combined with another known technology, and part thereof can be omitted or modified without departing from the gist of the present invention.

### REFERENCE SIGNS LIST

11 machining program storage unit; 12 analysis unit; 13 matrix calculation unit; 15 coordinate transformation unit; 16 command calculation unit; 17 switching unit; 18 polarity information setting unit; 21, 22 polarity information storage unit; 23 machine configuration storage unit; 25, 91 tool; 31 coordinate rotation angle; 32 origin position; 33 command coordinate value; 34 coordinate transformation matrix; 35 machine coordinate value; 36 move command; 37 axis combination information; 38 machine configuration information; 51 machine coordinate system; 52 tool coordinate system; 53 table coordinate system; 66 to 68 workpiece; 71 to 76 rotation axis; 81 to 83 table; 84 tilt base; 85P, 85Q, 86P, 86Q rotary table; 92P, 92Q tool base; 101 to 103 numerical controller; 150 machining program; 180 to 182 polarity information; 185 polarity information table; 200 to 203 machine tool.

1: A numerical controller comprising:
an analyzer to analyze a machining program and extract a rotation angle of a coordinate system specified in the machining program; and
a coordinate transformer to transform a coordinate value in the machining program into a coordinate value in a coordinate system of a machine tool to be controlled on a basis of polarity information created on a basis of at least one of a movement direction and a rotation direction of an axis of the machine tool, and the rotation angle.

2: The numerical controller according to claim 1, wherein
the rotation angle is a rotation angle of a rotation axis of the machine tool.

3: The numerical controller according to claim 2, further comprising a transformation information calculator to calculate coordinate transformation information for transforming a coordinate value in the machining program into a coordinate value in a coordinate system of the machine tool on a basis of the polarity information and the rotation angle, wherein
the coordinate transformer transforms a coordinate value in the machining program into a coordinate value in a coordinate system of the machine tool by using the coordinate transformation information and the polarity information.

4: The numerical controller according to claim 3, further comprising a setter to set the polarity information on a basis of at least one of the movement direction and the rotation direction, wherein
the transformation information calculator calculates the coordinate transformation information on a basis of the polarity information set by the setting-unit setter.

5: The numerical controller according to claim 4, wherein
the setter sets polarity information on the rotation axis after setting polarity information on the linear axis of the machine tool.

6: The numerical controller according to claim 1, further comprising a selector to select specific polarity information corresponding to an operation of the machine tool from a plurality of pieces of the polarity information, wherein
the analyzer extracts a combination of axes corresponding to the operation from the machining program, and
the selector selects the specific polarity information on a basis of the combination of axes.

7: The numerical controller according to claim 1, wherein
the coordinate value in the machining program is a coordinate value of an inclined plane coordinate system that is a coordinate system relative to an inclined plane.

8: A numerical control method comprising:
an analysis of analyzing a machining program and extracting a rotation angle of a coordinate system specified in the machining program; and
a coordinate transformation of transforming a coordinate value in the machining program into a coordinate value corresponding to a machine tool to be controlled on a basis of polarity information created on a basis of at least one of a movement direction and a rotation direction of an axis of the machine tool, and the rotation angle.

9: The numerical controller according to claim 2, further comprising a selector to select specific polarity information corresponding to an operation of the machine tool from a plurality of pieces of the polarity information, wherein
the analyzer extracts a combination of axes corresponding to the operation from the machining program, and
the selector selects the specific polarity information on a basis of the combination of axes.

10: The numerical controller according to claim 3, further comprising a selector to select specific polarity information corresponding to an operation of the machine tool from a plurality of pieces of the polarity information, wherein
the analyzer extracts a combination of axes corresponding to the operation from the machining program, and
the selector selects the specific polarity information on a basis of the combination of axes.

11: The numerical controller according to claim 2, wherein
the coordinate value in the machining program is a coordinate value of an inclined plane coordinate system that is a coordinate system relative to an inclined plane.

12: The numerical controller according to claim 3, wherein
the coordinate value in the machining program is a coordinate value of an inclined plane coordinate system that is a coordinate system relative to an inclined plane.

13: The numerical controller according to claim 4, wherein
the coordinate value in the machining program is a coordinate value of an inclined plane coordinate system that is a coordinate system relative to an inclined plane.

14: The numerical controller according to claim 5, wherein
the coordinate value in the machining program is a coordinate value of an inclined plane coordinate system that is a coordinate system relative to an inclined plane.

15: The numerical controller according to claim 6, wherein
the coordinate value in the machining program is a coordinate value of an inclined plane coordinate system that is a coordinate system relative to an inclined plane.

16: The numerical controller according to claim 9, wherein
the coordinate value in the machining program is a coordinate value of an inclined plane coordinate system that is a coordinate system relative to an inclined plane.

17: The numerical controller according to claim 10, wherein
the coordinate value in the machining program is a coordinate value of an inclined plane coordinate system that is a coordinate system relative to an inclined plane.
